(19) United States
(12) Patent Application Publication
(10) Pub. No.: US 2003/0187761 A1
(43) Pub. Date: Oct. 2, 2003

(54) Method and system for storing and processing high-frequency data

(76) Inventors: Richard M. Olsen, Zurich (CH); Devon S. Bowen, Maennedorf (CH); Curtis Meissner, Feldmeilen (CH); Gilles Zumbach, Zurich (CH)

Correspondence Address: PENNIE & EDMONDS LLP, 1667 K STREET NW, SUITE 1000, WASHINGTON, DC, 20006

(21) Appl. No.: 10/046,907

(22) Filed: Jan. 17, 2002

Related U.S. Application Data
(60) Provisional application No. 60/261,973, filed on Jan. 17, 2001.

(51) Int. Cl. G06F 17/60

(52) U.S. Cl. 705/35; 707/104.1

(57) ABSTRACT

High-frequency financial data analysis has significantly stressed current time series database implementations because of regularly requiring the request of tens of millions of irregularly spaced data points. In addition, describing the data in these systems makes it difficult for researchers to use. The present invention includes a method and system for storing and processing high frequency data. It also includes a language for the storage and query of the data.

### 1 RELATED APPLICATIONS

This application claims priority to provisional application no. 60/261,973 filed on Jan. 17, 2001, titled, “A Method and System for Storing and Processing High-Frequency Data”, the contents of which are herein incorporated by reference.

### 2 FIELD OF THE INVENTION

The present invention relates to the field of high-frequency financial data analysis. More particularly, the present invention relates to a method and system for managing time series data comprising a language for query and storage of the data.

### 3 BACKGROUND OF THE INVENTION

While some financial instruments are quoted at a frequency of a few times per day, others may be quoted a few times per second. Instruments include financial contracts for stocks, currency exchange, pork belly futures, etc. In addition time series data, containing tens of millions of prices, may be collected around the clock for a number of different instruments.

Researchers may use this data to look for correlations and phenomena in the financial markets on various time scales. For example, to examine the fractal nature of the data, it is essential to have access to all time scales. Therefore, all data events (called ticks) may be required to be saved and given a timestamp. This leads to irregularly spaced datasets. Fractal research is statistical in nature and, as such, often requires analysis of very large datasets for an instrument. Keeping such large datasets in memory is not feasible without supercomputer technology. However, due to the high cost of supercomputers, there is a need to perform such functions on typical computers.

In addition, there is also a need to request datasets that may not seem natural or obvious. For example, it may be desirable to request all currency exchange quotes for only Asian currencies, and again for European currencies, in order to compare the statistical distributions. Or one may request all quotes for all swap rates made by a given bank to see if that bank may be posting bad prices. It would be impossible to predict the scope of all possible data requests and to store the data appropriately from the start. Accordingly, there is a need for a database to be able to take a data description and return a desired time series.

But commercial databases do not fulfill these needs. Literature also contains little research in this area. Instead, most time series databases are geared toward small sets of regularly spaced data points. They usually assume a user wants an entire set at once. And they require the user to predefine these sets so that special data requests often are either not possible or are not easy to make.

Moreover, it is expected that the need for database systems that can meet these types of needs to grow. Research with high-frequency financial data is finding applications in diverse fields such as risk management and trading model development. Banks are embracing new solutions to these problems and often high-frequency data is being applied. In cases of risk management, for example, large matrices involving simultaneous access to thousands of high frequency time series need to be calculated.

Accordingly, there exists a need for a method and system for storing and processing high frequency data.

### 4 SUMMARY OF THE INVENTION

The present invention stores and processes high-frequency data. In one embodiment the present invention comprises a system for storing one or more time series comprising: a language for describing the storing of the one or more time series; and a subsystem storing the one or more time series in accordance with said language.

In another embodiment the present invention comprises a system for managing one or more time series comprising: a language defining a first one of the time series as a subset of a second one of the time series. In another embodiment the present invention comprises a system for managing one or more time series comprising a language defining a first one of the time series as a subset of a second one of the time series.

In another embodiment the present invention comprises a system for retrieving desired data from one or more time series comprising: at least one request comprising one or more restrictions for defining the desired data; and at least one utility retrieving data from the one or more time series that satisfies said one or more restrictions.

In another embodiment the present invention comprises a system for processing data from one or more time series comprising: one or more processing modules for processing the data; one or more connections for linking said modules in a network; and a first subsystem for activating said one or more processing modules and for moving the data through the network.

These and other embodiments and advantages of the present invention will be more readily apparent with reference to the detailed description and accompanying drawings.

### 5 BRIEF DESCRIPTION OF THE FIGURES

FIG. 1 shows an example of four possible time series subsets of a larger time series: 1) currency prices, 2) European currency prices, 3) German Mark prices, and 4) prices from the bank BGFX.

FIG. 2 shows a sample SQDADL definition to support currency exchange and deposit rates.

FIG. 3 shows examples of the parsing of some sample ticks: 1) a foreign exchange quote, 2) a foreign exchange transaction, and 3) a cash deposit interest rate quote.

FIG. 4 shows SQDADL queries which select the corresponding time series as defined in FIG. 1.

FIG. 5 shows the separation of a fully described tick into its filename and data record components.

FIG. 6 shows a data cursor, which is a software object that knows how to merge ticks from all the data files and remove all undesirable ticks.

FIG. 7 shows using ORLA Blocks to read and print data.

FIG. 8 shows an abstract block with 5 input and 3 output ports.

FIG. 9 shows a network to view input data along with its Exponential Moving Average.

### 6 DETAILED DESCRIPTION OF THE PREFERRED EMBODIMENT

6.1 High Frequency Data Repository for Financial Time Series

6.1.1 Introduction

Because keeping such large datasets in memory is not feasible without supercomputer technology, the present invention includes a data-flow-based, statistical package called Olsen Research LAboratory (ORLA) for this purpose. ORLA acts like an electronic circuit in which a network of various off-the-shelf pieces is constructed and data flows through it to calculate a desired set of results (moving averages, trading model signals, etc). This eliminates the need for a large local memory. The present invention may include a mechanism for slowly feeding data into the waiting ORLA process.

The invention was designed with generality in mind. In particular, it is not limited to financial data. It may be used anywhere that high volume time series data needs to handled.

One aspect of the present invention is called a repository rather than a database because the word repository is a more accurate description for flexibly storing and retrieving large number of ticks.

6.1.2 Time Series Model

A time series is a set of data points sorted in order of increasing time. In an abstract sense, one can define a “universal” time series as the time series of all recordable events that ever have and ever will occur. All other time series can be viewed as a subset of, or a restriction on, this universal set. Given any time series, a new time series can always be created by simply extracting a subset from it.

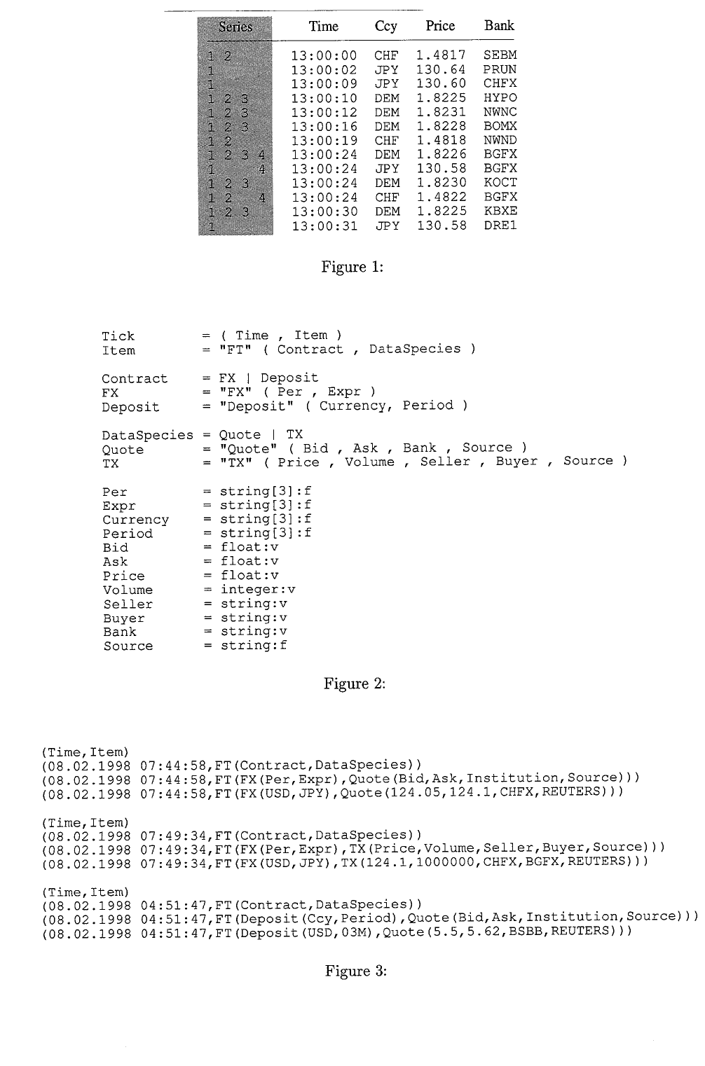

FIG. 1 contains a list of currency prices over a 31 second interval. The currencies are the Swiss Franc (CHF), German Mark (DEM), and Japanese Yen (JPY). Note is that this list is already a subset of larger sets. Examples of supersets might include the time series of all currency prices or even of all financial price quotes for all instruments. Conversely, this series may be broken into subsets. One may ask for all European currencies from the set, or one may want only German Mark prices, or one may want only prices from the bank BGFX.

All of these subsets have been of interest to researchers at one time or another. And thinking about them in terms of restrictions on a superset is instructive because it can lead to a model for data storage and, hence, to a language for repository query. The present invention includes a repository which treats data in this way.

This model for time series data is not usual. Most databases require the user to prepackage the data to be stored into various files. For example, if one wants the Swiss Franc currencies in one file and the German Mark in another, one would be required to predefine these files and to separate the data before storing it.

This preclassification is unnecessarily restrictive, requires the user to have too much knowledge of the packaging method, and leads to complicated query languages. For example, to get the BGFX bank quotes in our example above, the user would need to know that all these currencies are in separate files and would need to build a query by first combining these files and then asking for the BGFX quotes. This is clearly more complicated that simply asking for the BGFX quotes as a restriction of all known data.

6.1.3 Data Representation

The elimination of the file-based conceptual view means that each tick stands on its own in the repository without classification. For this to be useful, the data needs to be self-describing. This description can then take the place of the file as a handle for data queries.

The present invention includes a description language for this purpose called the Sequential Data Description Language (abbreviated SQDADL, and pronounced “skedaddle”). SQDADL is a BNF-style language with some restrictions to enforce a specific structure. FIG. 2 presents a sample SQDADL description for the storage of either currency prices or interest rates (deposits).

In one embodiment, each tick must contain a timestamp and this fact is reflected in the root-level statement “Tick=(Time,Item)”, which forces all ticks into this form. It is the only restriction placed on the data description of this embodiment. The “Item” reference can then be expanded as the user sees fit for the type of data to be stored. There is no implicit assumption that limits the repository to financial data.

FIG. 3 shows the derivation of a description for a quote on a currency exchange. In this case, the FT indicates a “financial tick” (as opposed to some other time series data), the FX indicates “foreign exchange” from one currency to another, and the Quote indicates at what prices the given bank is willing to buy (Bid) and sell (Ask) one currency for another. In simple terms, the bank of CHFX is willing to sell Japanese yen at a price of 124.1 yen per US dollar and one was told this by the Reuters news agency.

This string contains all the information needed to allow this tick to stand on its own. If this string were found written on a piece of paper on the floor, one would be able to enter it into the repository and then retrieve it as part of future queries. And yet the user is not forced to separate its components into file and record specifiers. The only restriction is that it conform to the syntax of the SQDADL description file.

FIG. 3 also illustrates how you can derive ticks for actual transactions and for interest rate deposit quotes. Given these definitions, interest rate deposit transactions also become possible. This is one of the nice features of the SQDADL language. Once the expansions of “Contract” and “DataSpecies” have been defined, they can be put together into various combinations which allows one to store many more instruments than one has considered. The recursive nature of the language is also a significant win in the financial world because many contracts are, in fact, recursive. Relatively “simple” contract types such as options, futures, and bonds may be combined to create, for example, an option on a bond future contract.

There is also significant advantage in keeping the ticks in the form of strings. It allows parsing to be dynamic, which means no code needs to be recompiled to handle new data types. One can simply modify the SQDADL definition and then, it is immediately able to store ticks of the new type in the repository.

6.1.4 Time Series Request Syntax

Because each time series is modeled as a restriction of another time series, it is easy to see how the SQDADL definition can lead to a way of specifying queries to the data repository. The present invention may include a syntax for restricting each of the fundamental types. The user can then combine these restrictions to define the desired time series. Restrictions may be implemented with expressions.

General Expressions Referring back to FIG. 2, each of the “leaf nodes” of the SQDADL parse tree is given a type indicator. These types are known to the repository as fundamental types and closely follow types inherent in most programming languages or communications standards. For each of these types, the present invention may define a set of expressions which can be used as a filter for deciding whether data is part of the requested series or not. This concept is very much like a regular expression or wildcard. In fact, for the string types, POSIX-style regular expressions could be directly used.

Thinking along these lines, one could send the following request to the data repository:

(*-*,FT(FX(USD,JPY),Quote(*,*,*,*)))

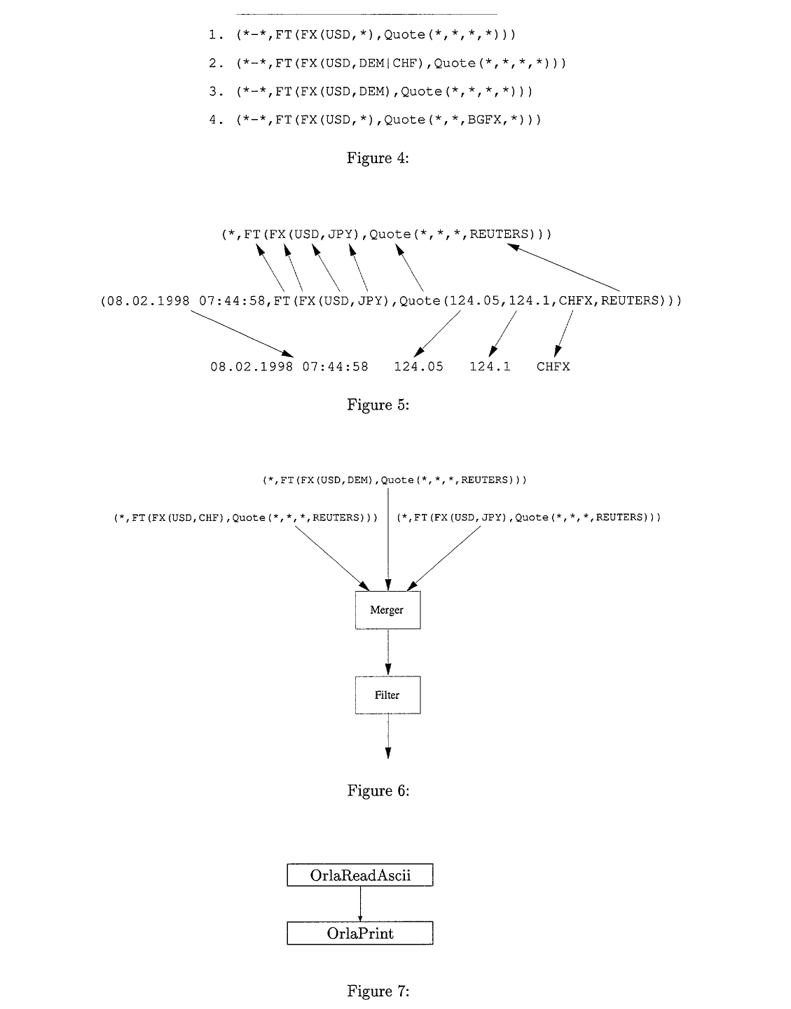

This request says that one would like all Japanese yen prices quoted against the US dollar over the entire range of time with no restriction on the prices, contributing bank, or the information source. FIG. 4 provides examples of requests to match each of the time series previously defined in FIG. 1.

There may be a different expression syntax for each of the data types. For example, the syntax of an integer expression will be different than the syntax for a string. The present invention determines which expression syntax will be used based on the types of the leaf nodes as indicated by the SQDADL parser.

It is not hard to imagine a set of expressions which allow the user to make very powerful and flexible filters for each data type. For example, one might use the expression “10<<12” in an integer field to request only ticks with values between 10 and 12. These filters can be added and modified as time goes on since they only affect the data retrieved by a query and not the storage process.

Time Expressions Because one is working with a time series repository, time is the handle by which one may access data. As such, expressions in the “Time” field are treated as a special case of the type-based expressions syntax.

To illustrate this, assume one may want to get the price of an instrument as it was at midnight on a certain date. The probability of there being a tick at exactly midnight is actually very low so one usually needs to ask for the tick before and the tick after so that some interpolation can be done. One might formulate this expression as “01.01.1990 00:00:00[−1..1]”.

The problem here is that the time expression is no longer a filter whose behavior can be determined only by the tick itself. If one asks for the tick before midnight, one does not know if this tick will be one second, one minute, or even one day before that hour. The behavior of any filter that will include this tick depends not only on the time of the tick, but also on the temporal placement of other ticks in the specified time series.

This implies that the processing of the time expression is something that must be considered deep in the repository machinery since the low level features of the time series are only known there. While all other restrictive expressions can sit at a higher level, and even, theoretically, on the client side, time expressions may be handled specially.

6.1.5 Storage of Data Ticks

All modern operating systems support the concept of a file with an associated name and data. While the abstraction of the present invention avoids the need for this classification of data on the user side, the present invention also maps the model onto a physical computer.

An implementation of the storage and request system that has been described is to simply store all the strings that a user gives to the repository in a single text file. A request then only requires one to go through the file, apply the restrictions, and then return the specified subset. While this would work, it is quite inefficient. The present invention employs some kind of grouping of like data behind the scenes in order to improve data query performance.

The present invention includes an architecture which allows the repository itself to store the data in the most efficient way it can based on hints given to it in the SQDADL configuration file. Referring back to FIG. 2, all leaf nodes in the parse tree not only have a type assigned to them but also a designation ‘f’ or ‘v’. This value is a hint to the repository and indicates whether this field is considered fixed or variable with respect to the most common query for data.

For example, in the sample SQDADL configuration, note that the currencies are all tagged with the “fixed” hint. This means that users are expected to more often ask for a fixed currency in their requests rather than a broader expression as a filter. Specifically, more queries are expected of the form:

(*-*,FT(FX(USD,JPY),Quote(*,*,*,*)))

than:

(*-*,FT(FX(USD,*),Quote(*,*,*,*)))

With these hints, the present invention has all it needs to store the data in a file on the physical machine. Given a string representation of a tick, two data buffers are created into which the string is divided. The first will become the filename and the second will hold the data record which will be appended to this file.

To ensure random access capabilities in each file, each data buffer must be the same length for a given file. This, of course, depends on the type of the data going into the buffer. For types of fixed size, for example integers, the data is simply written into the buffer. However, if the data is variable in size, such as a variable length string, another solution is needed. In this case, for each file a secondary storage file is created to hold all variable length data and its size. The offset into this file is then stored in the data buffer. Since the offset is simply an integer, a fixed size for all records is maintained in the primary file.

Now the tick and divide fields are parsed into the two buffers according to the following straightforward rules:

If the field is a non-leaf node token or it is a leaf node token with a hint of “fixed”, copy it to the filename buffer.

If the field is a leaf node with a hint of “variable” and with a constant size, copy it to the data buffer. Then place a “*” in the filename buffer.

If the field is a leaf node with a hint of “variable” and has a non-constant size, write its size and data to the secondary file and copy its offset to the data buffer. Then place a “*” in the filename buffer.

FIG. 5 shows how a given foreign exchange quote tick is broken up into the two buffers with the SQDADL configuration. For efficiency, the data record buffer holds binary versions of the data. And because the filename is often long and a rather strange collection of parentheses, wildcard characters, and commas, under most operating systems, a layer of indirection is required to map the appropriate filename onto a filename that the operating system can handle natively.

Once the parsing is complete, the appropriate file is opened and the data buffer is appended onto the end. If the file does not already exist, it is created beforehand. In this way, the repository is dynamic and can adapt to new ticks (for example, the creation of a new currency) but still hides the maintenance from the user.

6.1.6 Retrieval of Data Ticks

The hints given in the SQDADL definition lead to a pattern of possible filenames. For example, the hints we have given in FIG. 2 could lead to the filename:

(*,FT(FX(USD,JPY),Quote(*,*,*,REUTERS)))

If the user submits this same string as a request for data (with some range of time), the file is opened, the appropriate start time is found, and the ticks are given to the user until the end time is reached.

Of course, this is an optimal request. The present invention also handles non-optimal requests and allows users to specify expressions anywhere they please without having to know how the data is actually stored.

File List Selection Given a request for a time series, the present invention can determine all possible files that may have information relevant to the request. The request is parsed into tokens and three rules are applied to the set of all filenames:

If the given token is a non-leaf node, then select filenames that exactly match it.

If the given token is a leaf node and this leaf has a hint of “variable”, then select filenames that have a “*” in this position.

If the given token is a leaf node and this leaf has a hint of “fixed”, then apply this expression and select only those filenames that match it.

Using an example from FIG. 4, if the present invention is given the request:

(*,FT(FX(USD,*),Quote(*,*,BGFX,*)))

and the following filenames exist in the repository directory:

(*,FT(FX(USD,JPY),Quote(*,*,*,REUTERS)))

(*,FT(FX(USD,CHF),Quote(*,*,*,REUTERS)))

(*,FT(FX(USD,DEM),Quote(*,*,*,REUTERS)))

(*,FT(FX(DEM,CHF),Quote(*,*,*,REUTERS)))

(*,FT(FX(DEM,GBP),Quote(*,*,*,REUTERS)))

only the following files are selected for reading to service this request:

(*,FT(FX(USD,JPY),Quote(*,*,*,REUTERS)))

(*,FT(FX(USD,CHF),Quote(*,*,*,REUTERS)))

(*,FT(FX(USD,DEM),Quote(*,*,*,REUTERS)))

Given the hints in the SQDADL definition, it is clear that only these files can contain information that are of interest. The expression “USD” prevents the selection of the others. Yet because it is a variable field, the “BGFX” expression does not affect the list.

The Data Cursor Once a list of possible files are established a software cursor which can be used to pass over the files and hand the ticks to the user when requested may be created. In object oriented terms, a cursor object is instantiated by giving it a set of files from which to read, a desired starting time, and the entire expression pattern that defines the desired time series. Internally, each of these files is opened and a binary search is done to find the desired start time.

Once instantiated, the cursor provides two methods to the user, called next( ) and prev( ). The next( ) method returns the nearest tick in the requested time series after the current time. The prevo method returns the nearest tick in the requested time series immediately before the current time.

How the cursor actually does this is displayed graphically in FIG. 6. When asked for the nearest tick after the current time, it surveys all the files and chooses the tick with the lowest timestamp. It then applies the expression filter to this tick to see if it should be included in the requested time series. If not, it goes back to the files to get the next until a matching tick is found. Conceptually, this is merging the files in time series order and then removing any ticks that are not appropriate. The prevo method has the same implementation, but works by backing up in the files rather than moving ahead.

Servicing a Request A wrapper may be made around this cursor to service any request for data. For example, let's say the user has given us the following request string:

(01.01.1990 00:00:00[−10..5],FT(FX(USD,*),Quote(*,*,BGFX,*)))

This means that we want all ticks for any currency measured against the US dollar that came from the bank BGFX. And our time range is the 10 ticks before midnight 01.01.1990 and 5 ticks after. Steps for handling the request include:

Build the list of all possible filenames that could contain data that is needed for this request. This was done in the last section.

Extract the base time from the time expression. In this case, the base time is “01.01.1990 00:00:00”.

Instantiate a cursor for these files with this start time and pass it the full expression pattern that was given.

Make n calls to the prev( ) method to rewind the time series. In this case, n is 10.

Make n calls to the next( ) method and hand each to the user. In this case, n is 15, and represents the total length of the time series.

Here, the merging of all files by the cursor provides all possible appropriate ticks. But the cursor tests against the full expression to ensure that only those from bank BGFX are actually given. This is the time series that was requested.

6.1.7 Comments on Administration

The expensive part of a request may be data removal. Because a bank name has a hint of “variable”, it is put inside the data record rather than in the filename. This means many data records that do not match our expression may often need to be read just to get at those that do match. This is a waste of computer time.

One solution to this problem is to give the bank name a “fixed” hint. If this were the case, then it would be put in the filename and only the files that are really necessary need to be opened and merged. This would result, again, in a near optimal request because the merge operation is computationally trivial.

The decision as to whether to make a leaf node “fixed” or “variable” may be made by the repository administrator. If it is known that there is a small number of banks, then making “Bank” a “fixed” field may be a reasonable option, since only a few additional files would be created. On the other hand, the price field would certainly not be define as “fixed”, since there are essentially an infinite number of prices.

Another factor may be taken into account as well. The administrator may to decide which are the most common fields to be fixed in a user request. If users rarely put restrictions on the bank field, then this may be put in the data record because computer time will only be occasionally wasted.

Thus, it is not only the data itself that determines how the files are arranged but also the requests. When it is difficult to decide, it is better to err on the side of making a leaf node “fixed”. This results in faster request processing because fewer ticks need to be removed at run time. However, it should be stressed that the storage hints in no way affect the requests that the user can make. They only affect how fast those requests are handled. Indeed, the administrator can reorganize the file storage unbeknownst to the user.

6.1.8 Experience

The SQDADL code was designed to be flexible and easy to maintain. The goal was to be able to add new data types to the repository in a matter of minutes simply by defining the syntax of a new type and specifying the breakdown of its fields. This has been achieved and the data collection has been expanded with very little effort given to making SQDADL definitions.

Because SQDADL fully describes the financial instrument, a complex instrument such as an option on a bond future is represented by a complex SQDADL syntax. This makes it difficult for end users to remember the syntax. The present invention handles this problem in one of two ways. First, a layer is built on top of the normal repository requests so that simple data requests are done simply, leaving more complex requests to be done through the normal syntax. Alternatively, a tool helps the user dynamically build the requests strings by listing options and filling in boiler-plate components as needed. The present invention may include a functionality similar to the UNIX tcsh command interpreter or the X windows xfontsel font browsing utility.

The user may know that currency prices are stored and it is possible to find the list of those that are available. A meta-query database is available to store the various possibilities for each leaf node of a request string. A user could ask what currencies are available.

Finally, the use of flat files for data storage requires that all data arrive in time order so that it may be stored that way. To solve all time ordering issues that could arise, a b-tree storage mechanism may be used in the lower layer.

6.1.9 Conclusion

The described system has shown itself to be quite useful in the field. The flexibility of the SQDADL language has allowed the collection of over thirty instrument types with very little effort being spent on the data definition. The implementation has also resulted in fast response times because of the flat-file storage foundation.

The next section describes the database-flow-statistical package called ORLA for performing this high-frequency data analysis concept.

6.2 ORLA

6.2.1 Introduction

What is ORLA? The Olsen research LAboratory (ORLA) is a programming system designed and implemented to fulfill the following objectives:

To be a platform for economic research. ORLA can process large time-series data-sets. The term “large” includes data-sets whose size exceeds that of a typical computer's main memory.

ORLA runs in both historical (reading from fixed data files) and real-time modes (processing data as it arrives from external data sources).

These goals have been met by designing ORLA around a data-flow architecture. Rather than writing programs using the conventional concepts of data, functions and objects, ORLA uses the data-flow paradigm.

ORLA meets the following criteria:

It is extensible. ORLA includes a framework for users to add their own processing modules. The set of data-types known to ORLA is extensible.

It is transparent. The underlying actions of the ORLA system are hidden as far as possible. This simplifies what is required when developing new functionality within ORLA.

It is efficient. It imposes minimal overhead in processing whatever data is given to it.

Outline This section includes an introduction and a programming manual for ORLA. It includes the following chapters:

“Getting Started”, which introduces the main concepts used in ORLA and shows what goes on inside an ORLA application.

“Overview of the Block Libraries”, which introduce the main blocks and their organization into separate libraries.

“Error Handling and Debugging” gives advice for when things goes wrong.

These chapters enable a user to write an application using existing blocks.

Subsequent sections provide detailed information for users wishing to extend ORLA by developing their own blocks (processing modules). One chapter explains how the datum works. Another chapter concerns networks and their semantics. Another explains how to extend ORLA by writing customized blocks.

Some Features of ORLA ORLA includes the following features:

The capabilities of the new datum and SQDADL enable better block interfaces. Configuration dependencies between blocks are removed.

Most blocks have a configPair constructor.

A global factory method creates a network or portion of a network.

Datum allows one to define the SQDADL in a text file, which is parsed at the start of the program.

The datum classes are also used by the repository, which allows for a seamless integration of Orla with the repository.

Data may be handed over to a block as opposed to requiring the block to read the data explicitly.

A real-time processing mode for running production applications.

Support for timers working transparently for both historical- and real-time operations.

A smart network scheduler, activating blocks at run-time.

A network object which understands the block topology and detects feedback loops.

A network management interface to monitor and debug a running network.

Data types, which are able to represent arbitrary time-stamped financial data.

A simplified block class hierarchy.

Build-up, start and end times. Blocks can have a build-up time during which no data is sent forwards. An Orla network can have start and end times, before and after which no data is passed on inside the network.

Database interface. An Orla application can receive data from a real-time database.

Many blocks for financial computations.

Configuration files. There are classes for reading and storing configuration information in the form of key-value pairs.

The handling of time. A 64 bit representation of time has been defined, as well as a number of related classes like ObcTimeInterval, ObcTimeZone, ObcLocalTime and ObcMarket.

The handling of scaled time. This includes the definition of different TimeScales (ObcTickTimeScale, ObcMarketTimeScale, ObcThetaTimeScale and ObcPhysicalTimeScale), corresponding ObcScaledTime classes and ObcScaledTimeInterval.

ORLA's Implementation ORLA may be implemented in the C++ programming language. It is portable to different programming environments. Technically speaking, ORLA may be implemented using the Solaris SPARCworks C++ compiler (version 4.2) and the Rogue Wave libraries (version 7).

As noted above, ORLA is readily extensible. Researchers and developers may write their own ORLA blocks. Such blocks can be incorporated into the standard ORLA block library.

6.2.2 Getting Started

This section introduces the main terms and concepts used in ORLA. Reading this section explains what goes on inside an ORLA application and shows how to use the blocks and data-types belonging to the standard ORLA library.

The Overall Ideas ORLA is based on a data-flow paradigm: data flow through a network from block to block and are processed as they pass through each block. An ORLA application therefore consists of a network which in turn is defined in terms of blocks and their interconnections. The fundamental concepts in ORLA are those of network, block, connection and datum. Examples of networks are depicted in figures FIG. 7 and FIG. 9.

Conceptually, a block is a processing unit, possibly with internal states. A block communicates with the other blocks in the network by receiving data on its input ports and sending data to other blocks through its output ports. It processes the data flowing through it, thereby implementing some functionality. For example, a block may read data from a file, generate a synthetic regular time series, compute a moving average or a correlation. Each block generally performs one small, well-defined task; more complex tasks may be achieved by connecting blocks together.

A connection establishes how the data flow by linking the output port of one block to the input port of another. Creating a connection between two blocks is termed binding. The flow of data across a connection is termed a stream. At a global level, the connections define the topology of the network. A network is thus defined by its constituent blocks together with their connections.

The data are the items of information that are processed by blocks and sent along connections. A datum belongs to a certain data-type; for example, a floating-point value or a foreign exchange spot-price. A block accepts and produces data of given types. The types of data may be different for each port. A block may also modify the type of the datum it reads from an input port before it passes the datum on to the output port. However, when a connection is established between two ports, the type of the data produced by the output port must agree with the type of data accepted by the input port. For a port, these data-types remain constant for the lifetime of the connection.

Building and Executing a Network In order to build an application or perform a computation with ORLA, a network may be designed and built. A network is built by creating and initializing its component blocks and binding them together. Initializing the blocks may require configuration information such as the name of a file or the parameters for a computation. After all blocks are created and connected together, the network is considered built.

Once built, the network is then executed. This causes data to flow from block to block and to be processed along the way. This continues as long as there are input data available for processing or timers to be fired. When all the input data have traveled through the network and no pending timers exist, the network becomes idle and returns to the caller.

This flow of data through the network may be managed behind the scenes by a network scheduler known as the run-time system. The run-time system has two main responsibilities. First, it moves the data along the connections thereby managing the flow of data through the network. Second, it activates the various blocks in order for them to process the data or timer events (scheduling).

The purpose of the run-time system is to handle those issues that are necessary for implementing data-flow networks but which are essentially extraneous to the immediate application or computation. The run-time system is implemented efficiently and imposes minimal overheads.

A First Network Networks are generally straightforward to program. Consider the network shown in FIG. 7. This network reads from standard input and writes to standard output, thereby echoing its input. A C++ program to construct and run such a network may look like this:

#include <iostream.h>
#include <OrlaReadAscii.hh>
#include <OrlaNetwork.hh>
#include <OrlaPrint.hh>

| int main ( | |
|---|---|
| int | argc, |
| char** | argv |

)
{

OrlaNetwork net( argv[0] ); // Construct a network object
OrlaReadAscii in( cin ); // Build the block objects
OrlaPrint out ( cout );
net >> in >> out; // Bind the blocks
net.run(); // Run the network

}

Our network consists of an OrlaReadAscii block and an OrlaPrint block. The constructor of OrlaReadAscii expects either an istream& or a file name argument. The block reads data in ASCII from the input stream and interprets them according to the type given by the first line in the stream.

OrlaPrint is a block that takes any data given to it and prints them to a specified output stream. The stream to print on is specified in the block's constructor, in the above program on cout. The OrlaPrint block then passes these data on to the next block in the network. Because there is no other block, the data gets destroyed automatically.

The connections between the blocks are specified using the bind operator>>. The bind operator is a double arrow pointing in the direction in which the data are to flow. Here, the data flow from the OrlaReadAscii block into the OrlaPrint block.

The constructed network is then run. As expected, data are read and written. This continues until the producer block sends the end-of-data condition which is when all input data have been read. As soon as the consumer block has processed the end-of-data signal, the network detects that all blocks are idle and exits from the run.

Using the Makeconf Program The above program can be compiled and linked. In order to do this, we use the Makeconf program to generate a Makef ile. This Makefile can then be used by the make utility to compile and link the program, as given by the following exemplary steps:

$ cp /oa/build/main/libraries/orla/doc/simplel.cc

$ makeconf −p orla3 simple1.cc

$ make −f Make.solaris.mk

$ simple1</oa/build/main/libraries/orla/doc/simple1.dat

The Life of Blocks and Networks As noted above, a network is constructed by creating and initializing its constituent blocks and by binding these blocks together. The built network is then run. This starts the run-time system which in turn controls the network execution.

The execution of a network can be separated into three broad stages all of which are managed by the run-time system: initialization and set-up; processing the data and end-of-data handling. These three stages are conceptually similar: information flows down the network from the producer-only blocks through the producer-consumer blocks to the consumer-only blocks. During initialization, the data-types produced on each output port propagate through the network from the producer-only blocks downwards and this allows the blocks to check that they are correctly bound in the network. During the second stage, the data flow through the network, again from the producer-only blocks downwards, and are processed as they pass through the producer-consumer blocks. In the third stage, end-of-data indications percolate down the network. These give the blocks a chance to perform their final tasks and also possibly to clean up.

At the block level, these three stages are implemented by the configure( ), processData( ), processTimer( ), processEndOfData( ) and processEndOfRun( ) methods. These methods correspond to the initialization, processing and final computation stages respectively and are invoked directly by the run-time system.

For illustration, consider the example of a block that calculates a simple average. Its input and output streams consist of a flow of floating-point values with one output datum for every input datum. The configure( ) method checks that the block is correctly bound in the network by ensuring that it has one connected input and one connected output port. It also checks that the data to be received on the single input port are of the expected type. In general, block initialization is performed inside the constructor but some initialization may have to wait for the configure( ) method: it is only when configure( ) runs that the number of input and output ports are known as well as the data-types of the inputs. In this example, the internal counters need to be set to zero and this can be done inside the constructor.

Once all the blocks configure( ) methods have been invoked, the run-time system then repeatedly invokes their respective processData( ) methods. In this example, the method makes the appropriate calculation and sends the newly computed data to its output port and hence to the next block in the network. No timers are used, so method processTimer( ) will never be called.

The processEndOfData( ) method is called once for each port when each input stream is exhausted. In this example, the method does not need to do anything. However, for other kinds of block, the processEndOfData( ) method may also generate data. For example, if there was a block that generated no data except for a single datum when the input stream finished (say, an average of all the input data), this calculation would be done inside the processEndOfData( ) method.

Finally, once all input ports have received the end-of-data indication and all pending timers have fired, the block method processEndOfRun( ) gets called. This is the last chance for the block to forward information on to its consumers. On return, the run-time system will issue end-of-data indications to all output ports, in case this hasn't been done yet by the block itself.

A block is therefore fully characterized by its binding properties (ports and data-types) as well as its defining methods.

More About the End-Of-Data Indications As explained in the previous section, the blocks belonging to a network are initialized by having their configure( ) methods called. Similarly, the run-time system calls their processData( ) and processTimer( ) methods as data flow through the network. In both cases, this can be thought of as a flow of information down from the producer blocks.

The end-of-data stage is similar but more subtle. In general, the upstream blocks producing the data initiate the end-of-data indications. This generally corresponds to an end-of-file signal or to some pre-established conditions on the data such as a pre-arranged end-time having been reached. As the data are exhausted, the end-of-data signals percolate down the network and the appropriate processEndOfData( ) methods are invoked. This is therefore a gradual process as the data drain out of each connection. Some parts of the network are completed while others still receive data for processing.

The configure( ) and processEndOfData( ) methods are therefore distinct in that the configure( ) is a per block initialization whereas the processEndofData is a per connection indication. The former is invoked once per block but the latter is invoked once per input port.

This may actually be more complicated because any block may notify the scheduler that its task is over by calling the sendEndOfData( ) method from within its processData( ) or processTimer( ) methods. Blocks further upstream may continue processing data. However, these data cannot progress beyond the block that has issued the sendEndOfData( ).

In view of the gradual transition from processing data to end-of-data handling, a criterion must be chosen to determine when the entire network completes its execution. This is defined to be when all blocks representing the network have end-of-data indications from all blocks directly connected to it and have no pending timers.

Processing Time-Series The goal of ORLA is to process large time series. A datum is an elementary item of information from a ordered time-series; for instance, a (time-stamp, bid-price, ask-price) tuple from a financial time-series.

A time-series datum may contain a time-stamp. The individual data flow through the network and are processed in their natural time order; that is, the data traveling across a connection have increasing time-stamps. ORLA does not enforce this paradigm but all blocks involved in producing time-series preferably observe this constraint.

As long as blocks are connected in a linear fashion, the data remain ordered. However, when data follow different paths in the network, there is no synchronization of data among the various streams. This becomes an issue when several streams have to be merged into a new time-ordered flow by a block with multiple inputs. A block with multiple inputs receives time-ordered data on each of its input ports but these input streams are independent of one another. However, such a block must still produce ordered data on its output ports. It does so internally by looking at the time-stamps on its input data and sending them to the processing methods in the appropriate order. In this way, the network may have an arbitrary topology while the data coming into a block is still a time-ordered series.

Start- and End-Times A network always runs over a range of input data denoted by specifying the start and end times of this range. The producer-only blocks are programmed to deliver data in the specified time range.

Build-Up Delays An important notion for processing time-series is that of build-up delay. That is, a given block may require a certain amount of data for initialization purposes and before it can generate any output data. Typical examples include the computation of an exponential moving average (EMA) or a filter that needs sufficient data in order to initialize an adaptive threshold. If one wants a network to generate results from a given time, one may start it at an earlier time in order to allow the blocks to initialize themselves properly with enough data. The interval of time needed to initialize a network or a block is called the build-up delay.

An ORLA block may specify the time interval that has to elapse since the block received its first datum before any data is sent to the block's output ports.

ORLA also provides a method for calculating the network build-up delay by searching for the longest build-up path in a network. It must be emphasized that the build-up time can at best be estimated because it may depend on the data. For example, an adaptive filter may require 100 data in order to be properly initialized and the time interval required to have 100 data depends on the time-series.

Naming Conventions By convention, ORLA blocks and ORLA-specific classes may be given names that begin with “Orla”, whereas classes related to data-types begin with “Odt”. These prefixes denote all ORLA objects in a C++ program; for instance, the data-type Odt-TypeInstance or the block OrlaReadRepo.

Blocks and data-types may share the same naming convention except that block names may be constructed with a verb such as Read or Project as opposed to a noun. This is not a hard and fast rule.

Introduction to Data and Data-Types In ORLA, as in any typed programming system, data belong to a specific data-type. A block may specify what types of data it accepts as input in the same way a function of a conventional programming language specifies what types of arguments it accepts. A block also specifies the types of data it produces on each output port. For example, a computational block may accept and generate only floating-point data whereas a print block accepts data of any type.

The type of the data received by an input port must be compatible with that produced by the corresponding output port at the other end of the connection. As noted previously, a block checks its input data-types when its configure( ) method is invoked.

In order to accomplish this type checking, ORLA provides an internal mechanism to manipulate and reason about data-types. This typing mechanism supports single inheritance which means that a block may be defined as accepting data of a given type as well as all types derived from it.

Introduction to Blocks A block may be thought of as a small data processor or procedure. Blocks generally have an internal state that is held in the block object's variables. Blocks function independently of one another so that a block neither knows nor cares what its neighbors in a network may be doing, nor how its producers are generating their data. In other words, ORLA use a local model for treating data; the way for one block to communicate with another is to transfer data to it. Of course, two blocks may access a common object which can affect their behavior, not everything can be or should be done with data connections.

The behavior of a particular block typically depends on a set of parameters. As with other C++ classes, these parameters may be provided through different constructors, thus allowing each block to be customized appropriately.

Blocks are similar to the functions of conventional programming languages. They expect a certain number of arguments (input ports) of specified types and generate a certain number of outputs also of specified types. However, there are some subtle differences between blocks and functions. At this stage, thinking of blocks as functions is a good, first approximation.

As stated previously, a block has input and output ports and is connected via these ports to other blocks in a network. The number of input ports and output ports is a property of a block, as well as the types of data it accepts and produces.

A block with no input ports generates data for other Orla blocks, but receives its own input from outside an ORLA network; for example from a file or database. The data may also originate from the block itself; for example, a random number generator block.

Ports and Data-Types A typical block has both input and output ports through which data is received and sent. A block may require a fixed number of ports; for example, two input ports and one output port. Other blocks may accept a variable number of ports.

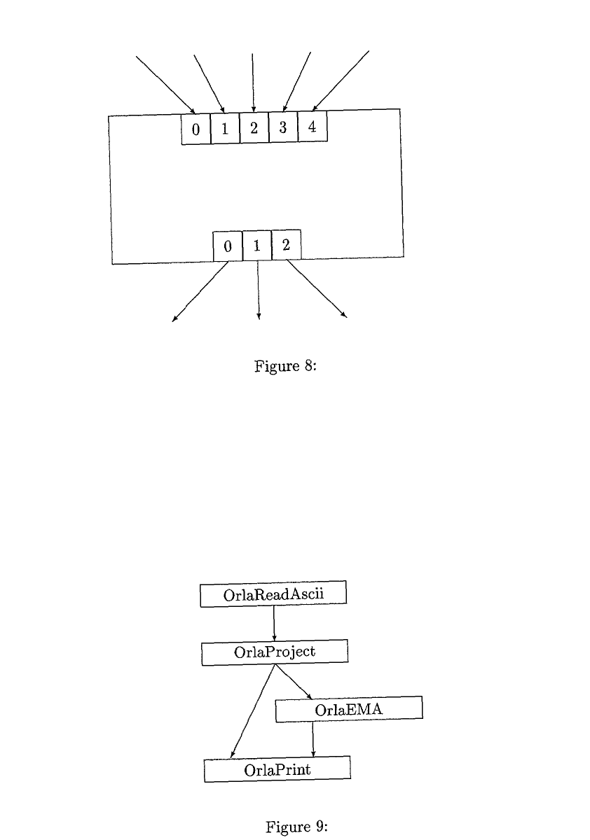

In many cases, the data-types and the functions of each input are identical, and therefore the order of binding is irrelevant. However, in the general case this is not necessarily so because the data-types or functionality may differ across ports. For this reason, the input and output ports are numbered, both sets starting at 0, and a data-type is associated with each port (see FIG. 8).

A given block must define what type of data it produces on each output port and check that the type of data being received on each input port is acceptable. For example, a block might have two input ports with the zeroth input port accepting double values and the first input port accepting foreign exchange spot-prices. Similarly the output might also be a stream of doubles. ORLA provides a mechanism for allowing a block to make these checks within a network.

Because ORLA's typing mechanism supports single inheritance, a port may accept any kind of data that belongs to a specified class or a sub-class thereof. This allows blocks to be developed that can process a set of related types rather than just a single, specific type. For example, the OrlaPrint block accepts any kind of data while the OrlaEMA block accepts doubles or vectors of doubles.

The connection between an output port and the corresponding input port is established by binding them together. However, this type checking is not done at “bind time” but rather at “execution time”; specifically when the configure( ) methods are invoked. This allows blocks to be created and bound in an arbitrary order.

Some Blocks of the ORLA Library The ORLA library contains several implemented blocks including the ones listed below for processing time series:

OrlaReadRepo( const RWCString& sqdadl ); Reads data from a database repository.

OrlaReadAscii( istream& in ); OrlaReadAscii( const RWCString& filename ); Reads limited types or ASCII data from an input stream, a f ilename or a file descriptor.

OrlaPrint( ostream& out ); OrlaPrint( const RWCString& filename ); Prints data in ASCII either to out or to filename.

OrlaWriteAscii( ostream& out ); OrlaWriteAscii( const char filename ); Writes limited types or ASCII data either to out or to filename.

OrlaProject( const char

functionName ); Applies the function functionName to the input data.

OrlaMerge( ); Merges multiple input streams of the same data type into a single output stream.

OrlaEMA( const ObcScaledTimeInterval tau ); Calculates an exponential moving average at scale tau.

OrlaDifferential( const ObcScaledTimeInterval tau ); Calculates a stochastic differential at scale tau.

OrlaSlicer( const ObcTime& start, const ObcTime& end ); Passes only the data between start and end.

An Example of a Small Network Next, how to build a small but useful ORLA network will be described. For this example we implement a network that prints a data stream along with its exponential moving average. We use an OrlaProject block to extract the “bid” value of the input foreign-exchange spot-price.

#include <OrlaReadAscii.hh>
#include <OrlaProject.hh>
#include <OrlaEMA.hh>
#include <OrlaPrint.hh>
#include <OrlaNetwork.hh>
#include <ObcScaledTimeInterval.hh>
#include <ObcTimeScale.hh>
int main ( int argc, char** argv )
{

ObcPhysicalTimeScale phyTimeScale;
OrlaNetwork net ( argv [0] );
// Create the blocks.
OrlaReadAscii in( “fx.data” );
OrlaProject bid( “bid” );
OrlaEMA ema( &phyTime Scale, 4 *
ObcScaledTimelnterval::minute() );
OrlaPrint print ( cout );
// Construct the network by binding the blocks together.
net >> in >> bid >> print;
bid.outPortC ( 0 ) >> ema >> print;
net.run(); // Run the network.

}

The network constructed by the above C++ is more easily viewed as a diagram, as shown in FIG. 9.

Note that the blocks are bound on successive ports by using the >>operator. In ORLA, each successive binding with the >>operator connects the next available output port to the next available input port of the respective blocks.

The >>operator is sufficient to bind most networks. To address an output or input port directly, the methods outPort( ) and inPort( ) can be used. This allows in- and output ports to be bound together by explicitly specifying their respective port numbers.

The statement “net.run( )” causes all available data to be processed. If one wants the graph to show data in a specified range—for example, between Jan 1, 1990 and Jan. 1, 1991—the start and end times must be specified. However, the build-up delay of the network also needs to be taken into account. (In this example, the presence of the OrlaEMA block causes the build-up delay to be non-zero). This modification of the network start time by the build-up delay can be specified as follows:

net.run( ObcTime( 1990,1,1,0,0,0 )—net.cumulativeBuildUpDelay( ), ObcTime( 1991,1,1,0,0,0 ) );

6.2.3 Introduction to the SQDADL

The data flowing between Orla blocks are highly structured, according to a ‘language’ called SQDADL. The name SQDADL stands for SeQuential Data Description Language. Technically, the SQDADL is a particular programming language described by a BNF grammar, and its full definition is given in appendix A. SQDADL includes the following features:

The top level of description is a union of five main fields:

1. The time, and possibly more information about the time properties of the time series. For example, the time series is a regular (homogeneous) time series with a given fixed time interval between the data.

2. The SeriesID, namely the description of the financial contract. For example, the value of seriesID is FX(USD,CHF), which denotes the spot foreign exchange rate between the USD and the CHF.

3. The DataSpecies, namely the value of the time series. For example, the value of DataSpecies is Quote(Bid, Ask, Institution), which denotes a quote issued by the ‘Institution’ with the given bid and ask. Many blocks are performing computations, using the DataSpecies Double or DoubleVec.

4. The Source, namely where this information is originating from. For example, the value of Source is Source(Re, *,*), which denote collected data from Reuter.

5. The Validity, namely the filtering information about this tick, according to the real time filter.

The SQDADL is recursive, through the contains a relationship. For example a future contract is based on an underlying, like FX(USD,CHF). This dependency is expressed with the SQDADL by the ‘Future’ containing an ‘Instrument’, and instrument can be any underlying. This recursiveness allows to describe complex derivative financial instruments.

There is a is a relationship defined between expressions written with the SQDADL. For example a ‘Future’ is a ‘Derivative’.

These three features give SQDADL its power and expressivity. Using this language, any information about any financial contract can be written simply.

When using Orla, the user is exposed to the SQDADL at two points: requesting data to the repository and the type checking between blocks. The data repository is using the same language to store data and for the query of data, allowing for a seamless integration between the data repository and Orla. Therefore, when requesting data to the data repository with an OrlaReadRepo block, the user may construct the SeriesID corresponding to the desired financial contract.

Orla uses the SQDADL both to pass data between blocks and to perform the initial type checking. During the type checking phase, if a block received a type that cannot be handled, the block will complain by throwing an exception giving the SQDADL for the received type and the expected type. The received type should have a is-a relationship with the type that the block is expecting. If this is not true, the block is not correctly bound and the network in invalid.

6.2.4 Overview of the block libraries

Blocks may be grouped into libraries according to theirs overall functionalities. Below is an introduction to some libraries and the blocks they contain.

inputOutput Inject data in a network from ‘outside’ (for example from the data repository or from a file), and write the data ‘outside’. The two most commonly used blocks are OrlaReadRepo to read data from the repository, and OrlaPrint to print on an ascii file the data passing through it (useful for debugging).

Blocks: OrlaGenQuote, OrlaPrint, OrlaPrintForPlot, OrlaPrintForTransform, OrlaReadAscii, OrlaReadRepo, OrlaReadSQDADL, OrlaTMDataSampler, OrlaTMGenerate, OrlaWriteAscii, OrlaWriteRepo, OrlaWrite™.

financial Blocks that perform some specific financial computations (i.e., to compute a crossrate with FX data).

Blocks: OrlaCrossRate, OrlaInvertFXQuote, OrlaSelectContract, OrlaSplitContracts, OrlaTX2Quote.

computational General computations with real data, like derivative, volatility, or generation of regular time series. Many blocks can ‘vectorize’ (i.e., do the computations on many time horizons). This is a very powerful feature of Orla, as the data can be computed and analyzed simultaneously on many time intervals using a simple network.

Blocks: OrlaBivariateMapping, OrlaDerivative, OrlaDifferential, OrlaEMA, OrlaGlobalSampler, OrlaHomogeneousConvolution, OrlaLinearConvolution, OrlaMA, OrlaMNorm, OrlaMStandarize, OrlaMVariance, OrlaMicroscopicDerivative, OrlaOBOS, OrlaOBOSAnalysis, OrlaOISActivity, OrlaQuoteRate, OrlaRTSAverage, OrlaRTSgenerate, OrlaRTSlag, OrlaRTSsampler, OrlaReturn, OrlaSMSAdaptive, OrlaSMSUniversal, OrlaScaleTime, OrlaTimeDifference, OrlaTurningPoint, OrlaUnivariateMapping, OrlaVolatility, OrlaWindowedFourier.

Abstract classes: OrlaConvolutionABC, OrlaIncrementalFunctor, OrlaRTSstackable, OrlaVectorisableABC.

statistical Basic statistical analysis, like correlation, moving correlation, or least square fit.

Blocks: OrlaCorrelation, OrlaIntraDayLeastSqFit, OrlaLaggedCorrelation, OrlaLeastSqFit, OrlaMCorrelation-1, OrlaMCovariance, OrlaMWeightedCorrelation.

histogram Compute histogram, probability distribution, conditional average, intra-week average, etc. All blocks in this library may use classes related to the function library, like OfctSampledAxis and OftlHistogram. Most of the blocks accept both scalar and vector data.

Blocks: Orla2dimHistogram, OrlaAverageCondDeltaTime, OrlaConditionalAverage, OrlaConditionalAverageSquare, OrlaHistogram, OrlaIntraDayAverage, OrlaIntraDayAverageCondDeltaTime, OrlaIntraWeekAverage,

OrlaIntraWeekHistogram, OrlaLaggedConditionalAverage, OrlaLaggedConditionalAverageSquare, OrlaLaggedHistogram

Abstract classes: OrlaIntraPeriodAverageABC, OrlaIntraPeriodHistogramABC. other Other time series related functionality, like selecting a sub-time period, removing data from a given period in the week (e.g. week-end), graphing the network (OrlaDaVinci, etc.).

Blocks: OrlaChop, OrlaCkp, OrlaDaVinci, OrlaDailySlicer, OrlaGrace, OrlaHead, OrlaMakeVector, OrlaMerge, OrlaProject, OrlaSlicer, OrlaSwitchOver, OrlaThin

orlaBaseClasses This library contains auxiliary classes used by some blocks. In order to mark this difference, the prefix is OrlaBc. Roughly, the functionalities are:

OrlaBcTimelntervalVector, OrlaBcScaledTimelntervalVector:

Vector of ObcTimeInterval and of ObcScaledTimeInterval. These classes are used by many blocks that perform computations or statistical analysis over several time horizons.

Univariate mappings:

A simple univariate mapping for double or vector of double, like exp(x) or a·x.

OrlaBcAbsMapping, OrlaBcAffineMapping, OrlaBcExpMapping, OrlaBcIRMapping, OrlaBcLinearElementMapping, OrlaBcLinearMapping, OrlaBcLogMapping, OrlaBcTauIntegrationMapping, OrlaBcUnivariateMapping, OrlaBcVectorDiffMapping, OrlaBcVectorComponent, OrlaBcPower, OrlaBcIdentifyMapping.

Bivariate mappings:

Bivariate mapping for double or vector of double, like xly.

OrlaBcBivariateMapping, OrlaBcAdaptiveVolatilityMapping, OrlaBcProductMapping, OrlaBcRatioMapping.

Kernel for convolution:

Give the form of the kernel used for computing convolutions with regular time series.

OrlaBcDerivativeKernel, OrlaBcDifferentialKernel, OrlaBcGaussianKernel, OrlaBcKernelABC, OrlaBcRectangularAverageKernel, OrlaBcSecondDerivativeKernel, OrlaBcSmoothAverageKernel.

Sampling procedure:

The sampling procedure to create regular time series from tick-by-tick data, for example the number of ticks, or a linearly interpolated price.

OrlaBcSamplerABC.hh, OrlaBcLastTickTimeIntervalSampler, OrlaBcLinearInterpolationSampler, OrlaBcTickCountSampler, OrlaBcTickTimeIntervalSampler.

orlacore This library contains basic classes needed for Orla, like timer, scheduler and network. When writing new blocks, the bases classes for all blocks, called OrlaBlock, is in this library.

6.2.5 Error Handling and Debugging

Errors and Exceptions The ORLA system reports errors by throwing exceptions. An error may occur during stages 4 to 6 of a network's lifetime or during block stages 3 to 5. By default, throwing an exception causes an error message to be printed and the process to be stopped. Exceptions may arise because:

The configuration used in a configPair constructor is not correct (for example a missing key).

A block is not correctly bound in a network, either because the number on input or output ports is wrong, or because the block cannot handle the type of the data he gets.

The global network topology is incorrect, for example it contains a loop.

The default behavior for exception can be changed in order to produce a core dump. A core dump may be produced for exceptions of type ObcException if the environment variable OBC EXIT EXCEPTION is set. This is useful for running a debugger to examine the exit condition.

Debugging Networks Because of the hidden complexity of Orla, which involves so many classes and a complex scheduling mechanism, the usual debugging tool like dbx or gdb may be of little use. Instead a user may insert OrlaPrint blocks into the network, and check that the data stream is what was intended. In this way, the bad block can be located. The parameters for this located block may not be properly set.

The block OrlaDaVinci is useful to ensure that the constructed network tpology matches what was intended.

6.2.6 Datum and Type

As already mentioned, a special library may be used to represent data-ticks and the corresponding data-types in the context of ORLA. This library, the so called Datum library, can also be used independently of ORLA.

First, some definitions are listed:

Datum is the notion for an Object representing a data tick.

Typesystem is a static object structure which holds.the information about what valid types are and how they stand in relationship.

Concrete Type is a object which describes a valid type in our typesystem. From concrete types we can create datum instances. Every datum belongs to a concrete type.

Abstract Type is a type from which we can not create a datum. These types are mainly used to specify what kind of datums we expect on, for instance, a certain input port of an Orla Block. In prose an abstract type could be

I expect Datums which have as DataSpecies a Quote

The Datum library provides the following functionality:

Creation of types from SQDADL string.

Creation of datums from concrete type instances.

Comparison of types (i.e., is type A a subtype of type B?).

Merging of types. Merging of Datums.

Conversion from tick objects to datum objects and vice versa.

Complete memory management of all dynamically created objects from the Datum library

Typesystem The typesystem may be built according to a grammar file. This grammar describes in a pseudo BNF syntax all valid types in the typesystem. The typesystem (the object structure, which models the typesystem) is dynamically built once at startup of each executable using the datum library. The typesystem is then used to parse SQDADL strings and create type instances, but also to compare types whether they fulfill an IsA-Relationship. The typesystem itself may be hidden from the user, the only access point is the class OdtDatumParser which helps to create type instances.

Abstract and Concrete Type Instances Consider two SQDADL strings, each representing a type:

Tick(Time( ),FX(DEM,CHF),Quote(,,),Source(,,),Filter(,,))

Tick(Time,SeriesID,Quote(,,),Source,Validity)

The first SQDADL string represents a concrete type, because every part of this type is well specified. The second SQDADL string represents an abstract type, because only the DataSpecies part, where we expect a Quote, is well specified, the other parts are held very general, to express that we do not care what stands there. There is an IsA-Relationship between these two types (the first type is a subtype of the second type, because a FX is a SeriesID, a Source is a Source and a Filter is a Validity.

The same as a C++ code example:

// The Datum parser to parse SQDADL strings into type instances OdtDatumParser parser;

const OdtConcreteTypeInstance* type1;

const OdtTypeInstance* type2;

// the two SQDADL strings

const RWCString sqdadl1;

const RWCString sqdadl2;

sqdadl1=“Tick(Time( ),FX(DEM,CHF),Quote(,,),Source(,,),Filter(,,))”;

sqdadl2=“Tick(Time,SeriesID,Quote(,,),Source,Validity)”);

// parse SQDADL string and create type instances

type1=parser.parseConcreteType(sqdadl1);

type2=parser.parseAbstractType(sqdadl2);

// check relationships between types

// ‘CHECK’ is a macro which prints out a warning, if

// the evaluated expression is not true

CHECK ( type1→isA(*type2)==true );

CHECK ( type2→isA(*type1)==false );

Note that the class OdtDatumParser has two different methods to parse SQDADL strings into type objects (one for concrete and one for abstract type).

The type instances that are created with OdtDatumParser are managed. This means that one does not have to delete them. They are deleted when the executable stops. Each unique type is represented by one type object. If the same SQDADL string is parsed twice, the same type object is returned.

Expanding of type shortcuts In order to avoid mistyping one can use Short-Cuts such as the following examples:

“Tick(Time,SeriesID,DataSpecies,Source,Validity)”

can be written as “Tick”

“Tick(Time,FX(,),DataSpecies,Source,Validity)”

can be written as “Tick(Time,FX,DataSpecies,Source,Validity)”

The fieldlist can be omitted if there is nothing to specify in it. Preferably every shortcut gets expanded in a way that the resulting type is as general as possible.

Merging of types Two types can be merged to create a new type. For two types A and B:

A is “Tick(Time( ),FX(DEM,CHF),Quote(,,),Source(,,),Filter(,,))”

B is “Tick(Time( ),SeriesID,Double(,),Source,Validity)”

type A merged with type B leads to type C

C is “Tick(Time( ),FX(DEM,CHF),Double(,),Source(,,),Filter(,,))”

The merging may follow the following rules:

1. Compare each component of type A with the corresponding component of type B.

2. If the component of type A has an IsA-Relationship to the corresponding component of type B then take the component of type A into the new type.

3. If there is no IsA-Relationship between a pair of corresponding components of type A and B take the component of type B into the new type.

For the example,

Time and Time are equal components, take Time into new type.

FX isA SeriesID, take FX into new type.

Quote and Double have no relationship, take Double into new type.

Source is a Source, take Source into new type.

Filter is a Validity, take Filter into new type.

The example with these two types is a common one. Consider of a block which has as input datum instance which has a Quote. The block is calculating the mean of bid and ask, and is replacing the Quote in the datum instances with a Double holding the mean. Thus, the output type of this block is the input type merged with (the above) type B.

Consider some code examples:

// header file (e.g. OrlaMyBLock.hh)
class OrlaMyBlock : public OrlaBlock
{

| ... | |
|---|---|
| private: | |
| const OdtAbstractType* mergeType_; | |
| OdtPath* | bidPath_; |
| OdtPath* | askPath_; |
| OdtPath* | valuePath_; |

}
// implementation file (e.g. OrlaMyBlock.cc)
void
OrlaMyBlock::configure()
{

...
OdtDatumParser parser;
RWCString sqdadl = “Tick(Time,SeriesID,Double,Source,Validity)”;
mergeType_ = parser.parseAbstractType (sqdadl);
outputType_ = inputType(0)->merge(*mergeType_);
bidPath_ = & inputType(0)->createPath(“Bid”);
askPath_ = & inputType(0)->createPath(“Ask”);
valuePath_ = & outputType->createPath(“DoubleValue”);
...

}
void
OrlaMyBlock::processData( const ObcTime& dataTime,

const OdtHandleVector& dataVec )

{

OdtInstanceHandle d = dataVec.at(0);
OdtInstanceHandle newD = d.createMerge(*mergeType);
newD[*valuePath] = (d[*bidPath]().asReal() +
d[*askPath]().asReal())/2;
send(newD);

}

Some constructs (accessing values, datum instance handling) in the above example will be explained later. In OrlaMyBlock::configure, the output type gets created. The input type is merged against the mergeType. The merging will replace the DataSpecies-part of the input type with the Double. Note that when merging to types, these types are not changed. Instead, a new type (the merged type) is produced.

In OrlaBlock::processData, an incoming datum instance is merged against the mergeType. The new datum produced will take over all the fields and fieldvalues of the old datum instance expect the Quote-Part is replaced by a Double-Part. This Double-Part will be filled afterwards with the mean of bid and ask of the old datum instance.

Datum instances A datum is implemented as a recursive object structure of objects of type OdtlnstanceBody and OdtValue, which represent one data-tick of a certain type. A class OdtlnstanceHandle, which hides the internals of this structure and takes the responsibility for the memory management of such datum instances, may simplify the handling of these object-structures.

For example:

void
foo()
{

OdtDatumParser parser;
const OdtConcreteTypeInstance* typel;

const OdtTypeInstance* type2;

const RWCString sqdadl1;
const RWCString sqdadl2;
sqdadl1 = “Tick(Time(),FX(DEM,CHF),Quote(,,),Source(,,),
Filter(,,))”;
sqdadl2 = “Tick(Time,SeriesID,Quote,Source,Validity)”;
Type1 = parser.parseConcreteType(sqdadl1);
type2 = parser.parseAbstractType(sqdadl2);
OdtInstanceHandle d = type1->createInstance();
CHECK ( d->isA(*type1) == true );
CHECK ( d->isA(*type2) == true );
// d goes out of scope
// underlying datum instances are removed automatically

}

Ownership of Datum Instances Because datum instances are passed through an Orla Network, the notion of Owner of a datum instances is important. It is evident, that after passing a datum instance to another block, the previous block is no longer able to change the values (or structure) of datum instance it gave away. The class OdtlnstanceHandle, which gives access to a datum instance, is implemented so that the ownership is passed on copy construction and assignment. If one does not want the ownership to be passed, one may use the duplicate( ) method of OdtInstanceHandle to duplicate the handle. For example:

OdtInstanceHandle d1 = type1->createInstance();
OdtInstanceHandle d2 = type1->createInstance();
OdtInstanceHandle dup = d1.duplicate();

| | |
|---|---|
| CHECK ( d1.isNil() == false ); | // both handles point to a datum instance |
| CHECK ( d2.isNil() == false ); | |

| CHECK ( dup == d1 ); | // dup and d1 point to the same datum instance |
|---|---|
| OdtInstanceHandle d3 = d2; | // call to copy-constructor ! |
| | // d3 took ownership of datum |
| | // instances d2 was pointing to |

| | |
|---|---|
| CHECK ( d2.isNil() == true ); | // because ownership was passed |
| CHECK ( d3.isNil() == false ); | |

| d3 = d1; | // assignment. d3 releases underlying datum instance. |
|---|---|
| | // d3 then takes ownership of datum |
| | // instance d1 was pointing to before. |

| CHECK ( d1.isNil() == true ); | // because ownership was passed |
|---|---|
| CHECK ( d3 == dup ); | // d3 and dup now point to the |
| | // same datum instance |

The behavior of OdtInstanceHandle is similar to the auto_ptr template of the C++ Standard Library.

The above example is rather theoretical. Practically, this passing of ownership may be used in the sendo method of OrlaBlock.

void

OrlaBlock::send(OdtInstanceHandle d)

The handle d is passed by value. This means that the ownership of the underlying datum instance is passed too.

OdtInstanceHandle d=type→createInstance( );

. . .

send(d);

CHECK( d.isNil( )==true );

Accessing values of datum instances Valid field values Each datum instance has field values. The corresponding type of a datum instance can specify the valid range for a certain field value. For example, the following type

“Tick(Time,FX(DEM,USD),Quote,Source,Filter)”

says that this a type for datum instances dealing with foreign exchange rates from Deutschmark to US-Dollar. If one has a datum instance of this type, the Per-Fieldvalue is always “DEM”. If one tries to set this field to another value, an exception may be thrown.

Setting of field values The following are possible ways to set field values of a datum instance.

1. Field per field d[/“Tick/FX/Per”]=“USD”;

2. Over a SQDADL string

sqdaldl=“Tick(Time(01.01.1999 12:00:00),FX(USD,CHF), Quote(1.47,1.48,),Source(,,),Filter(,,))”;

d→populateFieldValues(sqdadl);

3. Over a Tick object

OdtTick tick=repo→readNextTick( );

d→populateFieldValues(tick);

As seen in the above example, as long as the shortcut for a field name is unique (e.g. Per) the shortcut can be used. The SQDADL string and the tick object are checked to ensure that they are of the same type as the datum you want to populate.

Getting/Reading field values The values in the datum library are stored in OdtAny objects. An OdtValue object contains one object of OdtAny (to store its value) and one object of OdtAnyExpr, which describes the valid values for this field. In order that all the accessor methods in OdtValue, the underlying OdtAny object can be accessed directly for reading. This happens in two steps. With the [ ]-operator of OdtlnstanceHandle the OdtValue object that one wants to read is accessed. With the ( )-operator of OdtValue, the underlying OdtAny object is returned. An example:

OdtInstanceHandle d=type→createInstance( );

d[“Value”]=2.35;

OdtValue& value=d[“Value”]; // get OdtValue Object

OdtAny& anyValue=value( ); // get underlying OdtAny Object

float floatValue=anyValue.asRealValue( ); // get the REAL value

floatValue=d[“Value”]( ).asRealValue( ); // or written in one line

To convert a datum into a SQDADL string or into a Tick object, one can use the following methods:

OdtTick tick=d→tick( );

RWCString sqdadl=d→string( );

Usage of OdtPath objects to speed up access to field values A precompiled path may be used to access a field value. An example:

float
midPrice(OdtInstanceHandle& d)
{

static OdtPath& bidPath = d->type()->createPath(“Bid”);
static OdtPath& askPath = d->type()->createPath(“Ask”);
float mid = (d[bidPath]().asRealValue() +
d[askPath]().asRealValue())/2;
return mid;

}

Path-Objects are preferably created once to obtain the performance enhancement. A path may belong to a type. Path-Objects may be used for a datum object, if the path was created from the datums type instance or from a type instance which is a supertype. For example, to create a path object for the Timestamp field in every kind of datum:

static const RWCString base=“Tick(Time,SeriesId,DataSpecies,Source,Validity)”;

static const OdtAbstractTypeInstance* type=parser.parseAbstractType(base);

static OdtPath& timePath=type→createPath(“Timestamp”);

This timePath can be used for every kind of datum, because it was created by the most general type.

6.2.7 Networks

The Lifetime of a Network A network and its set of blocks may pass through several steps during its lifetime, including the following:

1. Creation of the network object.

2. Instantiation and binding of blocks to the network.

3. Global network checking.

4. Per-block configuration.

5. Execution of the network, processing of data and timer.

6. End-of-data and end-of-processing indications are sent through the network.

7. Execution of the network is completed.

Blocks may be instantiated and bound into a network in any order. After stage 2, all blocks are constructed and bound and the network is considered built.

In stages 3 and 4, the network is checked for validity. Stage 3 warns if a block is connected to itself.

During stage 5, data flow through the network and are processed. This continues as long as the network continues to receive data for processing or needs to fire timers.

At stage 6, end-of-data indications flow down the network. An end-of-data indication is sent from one block to another to inform the recipient that no more data are to follow. These end-of-data indications may be sent in one part of a network while data continue to flow elsewhere in the network. Therefore stages 5 and 6 are somewhat blurred together.

Stage 7 occurs when the run-time system has no more blocks which need to process data or timers. In this condition, the network stops executing and returns from the run( ) method.

Stages 3 to 6 may occur during the network method run( ). In C++ terms, the run-time system causes the various blocks' configure( ), outputType( ), processData( ), processTimer( ), processEndOfData( ) and processEndOfRun( ) methods to be called in the right order. Details are explained later.

After the network has completed running (i.e., after stage 7), all blocks are still bound and accessible to code outside the ORLA run-time system. This allows information to be extracted from the various blocks after the network has completed running. For example, a certain block may be queried about its final result for further processing by the main program.

Running a Network A network can be run several times, but a block typically runs only once. If an application requires re-running a network of blocks, the blocks may be built, run and destroyed repeatedly.

Start and End Times, Build-Up Time An ORLA network can be run by specifying the start and end-times. These times are passed to all blocks in the network. This causes them to start delivering data to the network at the given start time and to continue until the given end time. This allows a network for processing time-series to be run over a certain range of input data.

ORLA also supports the notion of a build-up delay for networks and allows a network to calculate its cumulative build-up time with the method cumulativeBuildupDelay( ). This gives an estimate of the cumulative build-up delay of the entire network. This is calculated by having each block report its own build-up delay via its own buildupDelay( ) method and working out the longest such delay path through the network.

Network Topology The binding of blocks allows the user to construct networks with arbitrary topologies. Such a network can also be looked at as a directed graph, where the blocks are the vertices and the connections are the edges. A directed graph without loops is called acyclic and has properties which are exploited by the ORLA run-time system.

The vertices in an acyclic graph can be sorted and therefore traversed unambiguously. During the network configuration phase, the blocks are sorted depth-first and then called in this top-down order. The same ordering is also used to activate blocks which have pending data or timers.

The network also offers a method which returns the corresponding adjacency matrix. Another method is available to search the network for feedback loops.

6.2.8 Blocks

An ORLA application may include user-defined blocks. In this section, we focus on the internals of a block and describe what is needed to build a new kind of block. We first discuss the theoretical aspects of writing a block before analyzing some complete blocks in detail.

Blocks may be implemented as C++ objects. A class representing a block is derived from the OrlaBlock class. In order to develop a new block, the programmer may provide specific class methods for which there are no defaults (pure virtual methods) and possibly also override default methods.

Design Goals A block may be a “thin”, light-weight entity, accomplishing one well-defined, simple task. Keeping the blocks light-weight allows them to be developed and maintained more easily. It also promotes code re-usage. In other words, blocks that perform simple, straightforward tasks are more likely to find themselves being reused in other areas than blocks that attempt to accomplish more heavy-weight, complicated tasks.

When writing a block, ORLA allows the developer to concentrate on the task at hand rather than worry about extraneous problems such as flow control or scheduling. These are issues that the ORLA run-time system automatically handles.

The Lifetime of a Block The stages of a block's lifetime include:

1. Construction of a block.

2. Binding the block into the network environment.

3. Checking and initialization of the block.

4. Running the block, processing data and timers.

5. End of data indication on individual input ports.

6. End of run indication.

7. Destruction of the block.

Stage 1 is implemented using the constructor for the block and thereby configures the parameters of the block object. As with all C++ classes, the constructor typically allocates resources and initializes the block into a valid state.

Stage 2, the binding of the block, is transparent from the viewpoint of the block. Binding is accomplished by using the >>operator or the inPort( ), outPort( ) methods to bind explicit ports.

Stages 3 to 6 happen during the execution of the network to which the block belongs; that is, during invocation of the network method runo.

Stage 3 allows a block to perform additional setup tasks after it is bound into the network. A block should check that it is bound into the network so that its input and output ports are properly connected. If necessary, it should also check that it will be receiving the correct data type on each input port.

Stage 3 also allows a block to perform additional initialization. Generally, most initialization is performed during construction (stage 1) but full initialization may have to wait until after binding. For example, the number of input and output ports and the type of data to be received on each input port are known only after the block is bound.

Stage 4 corresponds to the execution of the network. Data are passed to the blocks' input ports and flow through the network. Timers fire at the appropriate times.

Stage 5 denotes the end of data indication on each input port. It signifies to the block that no more data are to be expected on the corresponding input port.

When all timers have fired and all input ports have received end of data indications (stage 6), the block's work is completed and it performs no further processing. This is the last time the block is called and can be used to send final data or write out final information.

Stage 7 is the final destruction of the block. It may be implemented through the C++ destructor of the block. As for all C++ classes, the destructor typically generally cleans up and deallocates resources.

Implementation of the Block's Functions The functions of a block are implemented by overloading various virtual methods. The following sections describe these methods in detail. They are summarized in the following table:

| Name | Purpose | Default ? | Stage |
|---|---|---|---|
| configure( ) | Initialization | No | 3 |
| | and checking | | |
| buildUpDelay( ) | Calculating the | Yes | 3 |
| | build-up delay | | |
| outputType( p ) | Reports data-type | Yes | 3 |
| | on output port p | | |
| processData( ) | Processing the data | No | 4 |
| processTimer( ) | Processing the timers | No | 4 |
| processEndOfData( p ) | End-of-data indication | No | 5 |
| | on input port p | | |
| processEndRun | End-of-data on all | No | 6 |
| | input ports, no timers | | |

The ORLA run-time system calls these methods. Preferably these are not called directly. They are preferably marked as protected or private in the class definition.

The ORLA run-time system calls the configure( ) during stage 3 of a block's life. This is the block's chance to ensure that it is properly configured inside the network. For example, it should check that it is bound into the network with the correct number of input and output connections. It should also check that the types of data to be received on its input ports correspond to those expected. Finally, the configure( ) can allocate additional resources beyond those allocated inside the block's constructor. If there is no default for the configure( ) method, this must be provided for each block. The details of writing a configure( ) method are described later.

The ORLA run-time system calls the outputType( ) method in order to determine what data-type the block produces on a given output port. This also happens during stage 3. There is a default outputType( ) method which returns for output port p the same data-type as that being received on input port p. This default may not be suitable for all blocks. If not, a new definition must be provided instead. This is described later in this section.

The method buildUpDelay( ) is called to determine how much time the block needs to build up its internal state before it can start sending meaningful data. By default, a block does not need build-up time, and the default method returns a zero time interval. buildUpDelay( ) is called at least once during the checking in initialization of the block and its return value is stored in the internal state of the block. If the delay is greater than zero, the block doesn't send any data to its output ports until that time has elapsed since the first datum sent in the block.

As buildUpDelay( ) can be called more than once during the initialization phase, the return value should not depend on any changing status of the class or object.

During stage 4 of a block's life, the ORLA run-time system repeatedly calls the processData( ) method in order to process data. On each call, it hands over data to the block which is equal to or younger than the data passed on in the previous call. This continues until there is no more data to process. The details of writing a processData( ) method are described later.

The ORLA run-time system calls the processEndOfData( ) method in order to inform the block that no more data are to be expected on a given port. This happens during stage 5. The processEndOfData( ) method is called once for each input port of a block. Its single argument specifies which port is exhausted. When processEndOfData( ) notifications have been received for all input ports, the processData( ) method will not be called again. As long as pending timers exist, processTimer( ) method will still be called.

Finally, method processEndOfRun( ) is called. This is the last chance for the block to send information on to its consumer blocks. Afterwards, end-of-data indications are automatically sent along those paths (that is, each consumer will receive an processEndOfData( ) notification).

Writing Your Own Configureo Method The ORLA run-time system calls the configure method at least once in order to perform checking before the network begins execution. A configure( ) should check that it is bound to the correct number of input and output ports and that each input port is to receive data of the correct data-type. In order to facilitate writing a configure( ) method, ORLA makes the following procedures available:

void expectInPorts(Eq,Le,Ge)( unsigned int n);

Throws an exception if the number of connected input ports is not matching the comparison.

void expectOutPorts(Eq,Le,Ge)( unsigned int n );

Throws an exception if the number of connected output ports is not matching the comparison.

void expectInType( unsigned int p, const OdtTypeInstance& t );

Throws an exception if the type on input port p is not t or a subclass of t.

void expectType( const OdtTypeInstance& t1, const OdtTypeInstance& t2 );

Throws an exception if type t1 is not a t2 or derived from t2.

unsigned int nbInPorts( ) const;

Returns the number of input ports.

unsigned int nbOutPorts( ) const;

Returns the number of output ports.

The following code demonstrates the configure( ) of a block requiring one input and one output port. The input port is constrained to accept data containing a Double as DataSpecies object. Note how the data type object is constructed in the block constructor already.

void
OrlaYourBlock::OrlaYourBlock()

: OrlaBlock( “OrlaYourBlock” ))

{

OdtDatumParser parser;
typeDouble_ = parser.createAbstractType(

“Tick(Time,SeriesId,Double,Source,Validity)”);

}
void
OrlaYourBlock::configure ()
{

expect InPortsEq( 1 );
expectOutPortsEq( 1 );
expectInType( 0, typeDouble_ );

}

Writing Your OwnoutputType( ) Method Therun-timesystemcallstheoutputType( ) method in order to determine what type of data will be produced on a given output port. As noted above, there is a default outputType method which returns for output port p whatever type of data is to be received on input port p.

It is illustrative to see how this default implementation of the outputType( ) method is written:

const OdtTypeInstance*
OrlaBlock::outputType( unsigned int port )
{

return inputType( port );

}

Here we see that this method makes use of the inputType( ) utility method. The latter returns whatever type of data are to be received on the given input port.

If it is known that data of a specific type are to be generated on an output port, code such as the following suffices to inform the run-time system accordingly:

const OdtTypeInstance*
OrlaYourBlock::outputType( unsigned int port )
{

return typeDouble_;

}

The above code states that data of type typeDouble_are to be generated on all output ports. The object could be created inside the constructor as seen in the previous subsection.

A block may have its outputType( ) method called before its configure( ).

Writing Your ProcessDatao Method When the network starts executing, the ORLA run-time system calls the processData( ) method whenever there's data which can be processed. The data is handed over to the block as a vector representing the set of input ports the block has. Each datum in the vector has the same time stamp and the run-time system guarantees that in a future call, data with the same or a younger time will be handed over. Typically, a block processes the incoming data and then calls one of the following methods:

void send( OdtInstanceHandle& d, unsigned int p );

Sends a datum to the consumer that is connected to output port p.

void send( const OdtHandleVector& dataVec );

Sends a data vector to the corresponding output ports. Ignores vector elements which contain zero pointers.

void discard( OdtInstanceHandle& d);

Explicitly discards a datum. Not needed anymore.

void discard( const OdtHandleVector& dataVec );

Discards a vector of data.

void sendEndOfData( unsigned int p );

Sends an end-of-data notification to the consumer that is connected to output port p.

void sendEndOfData( );

Sends end-of-data notifications to all existing output ports.

The following code fragments helps to clarify this. For a trivial “null” block, which simply forwards all input data to the corresponding output ports, the necessary code is:

void
OrlaYourBlock::processData(

const ObcTime& dataTime,
const OdtHandleVector& dataVec)

{

send( dataVec );

}

Or, for a merging block with any number of input ports, where all incoming data must be transferred to a single output port:

void
OrlaYourBlock::processData(

const ObcTime& dataTime,
const OdtHandleVector& dataVec
)

{

for( unsigned int i = 0; i < dataVec.entries(); i++ )

send( dataVec.at( i ), 0 );

}

Ownership of Data A block receives a vector OdtHandleVector of OdtlnstanceHandle objects when the processData( ) is called. The block becomes the owner of that data. Owning data means that the block has the right to change its contents. Because when passing an instance of OdtlnstanceHandle by value the ownership will be passed too, no explicit deletion of datums are necessary.

The End Of Data Condition Eventually the data stream on an input port will become exhausted. In other words, no more will arrive on that port. The run-time system notifies a block of this fact by calling its processEndOfDatao method. The single argument to the processEndOfData( ) method indicates which port is exhausted.

A block may check this condition for a given input port by using the endOfData( ) method.

A block may explicitly send an end-of-data indication to a consumer by invoking the sendEndOfData( ) method.

Writing Your ProcessTimer( ) Method This method serves to process timer events. Whenever time has come to fire a pending timer, the processTimer( ) method is called. Initially, a timer needs to be set in a different method, typically during the configuration phase.

Consider, for example, a block which wants to compute a hourly average for incoming data on port 0. It forwards the data transparently to output port 0 and, every hour, sends a datum containing synthesized information to output port 1.

Therefore, to setup a hourly timer metronome, we use a timer and set it on the arrival of the first datum in the processData( ) method:

OrlaYourBlock::OrlaYourBlock()

: OrlaBlock( “OrlaYourBlock” ),

timer_( timerQueue() ),
count_( 0 ),
sum_( 0 )

{}
void
OrlaYourBlock::processData(

const ObcTime& dataTime,
const OdtHandleVector& dataVec)

{

OdtInstanceHandle d = dataVec.at(0)[“Double”];
if ( count_++ == 0 ) {

ObcTimeInfo humanTime = dataTime.timeInfo();
humanTime.minute_ = 0; // Truncate first arrival
humanTime.second_ = 0; // time to the
humanTime.microsecond_ = 0; // full hour .
// Set a metronome to go off every hour,
// starting on the next full hour
timer_.set( ObcTime( humanTime ) + ObcTimeInterval::hour(),

ObcTimeInterval::hour() );

}
sum_ += d[“Value”]().asReal();
send( dataVec.at( 0 ), 0 );

}

Whenever the timer fires, a new datum is created and filled in with the desired data acquired during the processing of incoming data:

void
OrlaYourBlock::processTimer(

| const ObcTime& timerTime, | |
|---|---|
| OrlaTimer* timer | // pointer to our timer_ instance variable |
| ) | |

{

OdtInstanceHandle datum = inputType( 0 )->createInstance();
datum[“Timestamp”] = timerTime;
datum[“Value”] = sum_ / count_;
send( datum, 1 );

}

The End Of Run Condition Eventually, all input ports have received end-of-data indications and all pending timers have been fired. At that point, the processEndOfRun( ) method is called. It is the last chance for the block to send data on to its consumers. On return, end-of-data indications are sent to all consumer blocks.

Block Examples In this section we describe in detail the internals of several simple blocks.

Block example: Class OrlaTotalAverage Our first example consists of building a single-producer/single-consumer block that computes and sends out a running average for each input value. The block is designed to read and send double precision floating-point values. We have chosen a simple averaging function so that we can concentrate on what is involved in building a user-defined block. We name this block OrlaTotalAverage, following the naming convention of prepending blocks defined at O&A with “Orla”.

As required for user-defined blocks, we derive OrlaTotalAverage from the class OrlaBlock. As a C++ class, this block has both state and member functions. The necessary state to calculate a total average are a count and a sum. It defines the configure( ) method and overrides methods processData( ) and outputType( ).

The class definition looks like this:

class OrlaTotalAverage : public OrlaBlock {
// Compute the average so far. Send out a datum for each datum received.
public:

OrlaTotalAverage ( OrlaNetwork& net);

protected:

virtual void configure();
virtual const OdtCompositeType& outputType( unsigned int port );
unsigned int count_;
double sum_ ;
const OdtTypeInstance* typeDouble_;

private:

virtual void processData( const ObcTime& dataTime,

const OdtHandleVector& dataVec );

};

For class OrlaTotalAverage we first define the constructor that initialises its state:

OrlaTotalAverage::OrlaTotalAverage( OrlaNetwork& net )

: OrlaBlock( net ),
count_( 0 ),
sum_( 0.0 ) )

{

OdtDatumParser parser;
typeDouble_ = parser.parseAbstractType(

“Tick(Time,SeriesId,Double,Source,Validity)”);

}

Next we write the block's configure( ). Recall that the configure( ) is called after the network is built and before the network is run. The configure( ) is the block's opportunity to check its state within the network. We check that the number of input and output ports is correct; that is, 1 and 1. We also ensure that the input type is an OdtDouble.

void OrlaTotalAverage::configure()
{

// Check that we have exactly 1 input port and 1 output port
expect InPortsEq( 1 );
expectOutPortsEq( 1 );
// Ensure that my input type is correct .
expectInType( 0, typeDouble_ );

}

The utility functions expectInPortsEq( ) and expectoutPortsEq( ) are self-explanatory. In this example, they check that this block is bound to one producer block and to one consumer block. If the number of ports is not as expected, these functions indicate an error by throwing an exception.

We once create a data type object which we can work with and validate the input port receives data of the same type. The function expectInType( ) takes as argument an input port number and an OdtTypeInstance and indicates an error if the data type received on the specified port does not match what is specified (or is not inherited from the type specified). In this case, we check that input port 0 is to receive data of type Double.

The heart of the OrlaTotalAverage block is its processData( ) method. We count the number of items received and their running total. For every received input datum we output the calculated average. The code looks like this:

void OrlaTotalAverage::processData(

const ObcTime& dataTime,
const OdtHandleVector& dataVec
)

{

// Use an alias to point to the OdtDouble object inside the datum.
OdtInstanceHandle d = dataVec.at(0)[“Double”];
// Increment n and add to sum.
count_++;
sum_ += d [“Value”]().asReal();
// Owning the datum so can change it.
d[“Value”] = sum_ / count_ ;
// Send the data on to our consumer.
send( dataVec.at( 0 ), 0 );

}

For each datum available, we refer to it with a OdtInstanceHandle object named d. We know from the configure( ) that all received data are have a Double part. Any changes to d are automatically reflected in dataVec. at (0).

We then make the average calculation and assign the result of this calculation back to dataVec. at (0) via d. We are allowed to do this because we own d and hence are allowed to change its value. This reuse of incoming data in this way is common in writing blocks. It is generally more efficient to reuse received data than to deallocate the incoming datum via discard( ) and to allocate a new one to be sent on. Finally, the send( ) method passes the modified datum along to the consumer.

The processData( ) function above is called repeatedly as long as there are data available on the input port.

We also provide an explicit outputType( ) method. This informs the run-time system that all data generated by this block are OdtDoubles.

const OdtTypeInstance*
OrlaTotalAverage::outputType ( unsigned int port )
{

return typeDouble_;

}

This method definition isn't strictly necessary for this block. As the block doesn't change the output type, the default implementation would be sufficient.

Block example: Class OrlaOccasionalAverage The above example demonstrates how to build blocks that take one input stream and produce one output stream. Here we consider a slightly more complicated example, where we wish to output a running average but not every time we receive an input datum. We call this new class OrlaOccasionalAverage. This example demonstrates using inheritance to refine an existing block in order to develop a new kind of block. It also demonstrates how to parameterize a block through its constructor and how to supply an processEndOfData( ) method.

Let us assume that we wish to output the running average every nth data point where n is defined outside the class. A final average should also be produced when the input stream is exhausted. This example is similar to the previous one. This suggests that one way of implementing such a block is to derive it from class OrlaTotalAverage and thereby reuse the latter's functionality.

The configure( ) and outputType( ) methods are the same as for class OrlaTotalAverage and hence need not be redefined. However, the constructor is different as is the processData( ) method. We also need to provide an processEndOfData( ) method in order to provide the special treatment necessary when the input stream finishes.

First we present the class definition:

class OrlaOccasionalAverage : public OrlaTotalAverage {
public:

OrlaOccasionalAverage ( unsigned int n );

protected:

virtual void processEndOfData( unsigned int port );
virtual void processData( const ObcTime& dataTime,

const OdtHandleVector& dataVec );

private:

unsigned int n_;
ObcTime lastTime_;

};

The constructor copies the argument n to an internal variable, n_ as shown below:

OrlaOccasionalAverage::OrlaOccasionalAverage ( unsigned int n )

: OrlaTotalAverage(),
n_( n )

{}

The processData( ) function is as follows:

```
void
OrlaOccasionalAverage::processData (
    const ObcTime& dataTime,
    const OdtHandleVector& dataVec
    )
{
    lastTime_ = dataTime; // store the time for later use
    OdtInstanceHandle d = dataVec.at( 0 ) [“Double”];
    // Increment count and add to sum.
    count_++;
    sum_ += d[“Value”]( ).asReal( );
    // This block only sends down every nth data. Is it the nth?
    if ( count_ 0% n_ )
        // It isn't the nth datum.
        discard ( dataVec.at(0) );
    else {
        // Change to new value and send it to our consumer(s).
        d[“Value”] = sum_ / count_ ;
        send( dataVec.at(0), 0 );
    }
}
```

As in the previous example, we alias the incoming datum using a reference and make the necessary calculation. The above example illustrates what must happen if we don't wish to send our received datum on to our consumer. In this case we can use the discard( ) method to free the datum rather than send( ) it on.

In the previous example, we did not need to use the end-of-data condition on the input port. In this example, we use the processEndOfData( ) method to perform one last task before finishing. If we have received fewer than n data since we last sent a result, we send our final result to the consumer. Of interest here is the fact that we are fabricating brand-new data; that is, we send a newly generated datum rather than retransmit one that we have received from our producer.

```
void
OrlaOccasionalAverage::processEndOfData (
    unsigned int port
)
{
    // It is the definition of this block to send down the remaining data.
    // It does not need to send anything down
    // if we are a multiple of the n-th.
    if (count_ % n_ ) {
        // Create a datum with the same time as the input port
        OdtInstanceHandle datum = inputType( port )->
        createInstance( );
        // Set attributes of the datum.
    d[“Timestamp”] = lastTime_;
    d[“Value”] = sum_ / count_;
        // Send the newly created datum to our consumer.
        send( datum, 0 );
    }
}
```

Block example: Class OrlaSlicer The above block building examples focus on blocks that process data. In this example, we focus on a block which uses timers. A simple example is a slicing block which only lets data through for a certain time period. First, the class definition:

```
class OrlaSlicer : public OrlaBlock {
public:
    OrlaSlicer( const ObcTime& start, const ObcTime& end );
protected:
    virtual void configure( );
    virtual void processData( const ObcTime& dataTime,
            const OdtHandleVector& dataVec );
    virtual void processTimer( const ObcTime& dataTime, OrlaTimer* );
    OrlaTimer timer_;
    const ObcTime start_;
    const ObcTime end_;
    bool inSlice_;
};
```

The constructor simply stores start and end time. We use a boolean variable to indicate if we are inside the given time slice or not:

```
OrlaSlicer::OrlaSlicer(
    const ObcTime& start,
    const ObcTime& end
    ) : OrlaBlock(“OrlaSlicer” ),
        timer_(timerQueue( ) ),
        start_( start ),
        end_( end ),
        inSlice_( false )
{
}
```

As usual, the configure( ) checks the number of input and output ports. The block is transparently passing data from an input port to the corresponding output port, so the number of output ports must not be larger than the input ports. We don't check the data types, because we don't need to process any data. We set the timer to go off when the start time is reached.

```
void
  OrlaSlicer::configure( )
{
    expectOutPortsLe(nbInPorts( ) );
    timer_.set( start_ );
}
```

Because we are using timers in this example, the processTimer( ) method needs to be overridden. It is called the first time when the start time is reached. We then re-set the timer to go off a second time at the end of the interval.

```
void
OrlaSlicer::processTimer(
    const ObcTime& timerTime,
    OrlaTimer* timer
    )
{
    if ( !inSlice_ ) { // did the start time fire?
        inSlice_ = true;
        timer->set( end_ );
    } else {
        inSlice_ = false;
        sendEndOfData( ); // we're done, no more data from us
    }
}
```

The processData( ) method is very simple, all it needs to do is to check whether the block is inside the time slice or not and thus send the data on or discard it.

```
void
OrlaSlicer::processData(
    const ObcTime& dataTime,
    const OdtHandleVector& dataVec
    )
{
    if ( inSlice_ ) send( dataVec );
    else discard( dataVec );
}
```

This block could be implemented without the use of a timer.

Blocks with Multiple Inputs In the preceding example, we have already seen a block with (potentially) multiple input ports. However, that block didn't care about what kind of data it received, it simply passed it on. In most cases, though, input data is analyzed and processed before some other data is passed on to the consumers.

Typically, when the processData( ) method is called, not all input ports have data. For example, a block might have no input datum on port 0 but several pending data on input port 1. During historical-time operations, this block will not be called until data are ready on both ports. During real-time operations, however, the block doesn't wait for both ports to carry at least one datum. Whenever the block is activated, the oldest datum on any of the two ports is handed over to the block via the processDatao method.

Block example: Class OrlaMerge As an example of a block accepting multiple inputs, we examine the library class OrlaMerge. It takes N input streams and produces one output stream. The input data arrive in time-ordered sequence on each input port. Method processDatao is called repeatedly for a vector of data with the same time stamp. The output consists of the input data merged together so that time ordering is preserved.

```
class OrlaMerge : public OrlaBlock {
public:
    OrlaMerge( );
protected:
    virtual void configure( );
    virtual void processData( const ObcTime& dataTime,
        const OdtHandleVector& dataVec );
};
```

During the configuration phase, we test the number of input and output ports and also that all inputs are of the same type. Stated more accurately, that ports 1 to N are of the same type or subclasses of port 0. Here, we use the nbInPorts( ) method which returns the number of input ports that are in use:

```
void OrlaMerge::configure( )
{
    expectInPortsGe( 1 );
    expectOutPortsEq( 1 );
    const OdtTypeInstance* type = inputType( 0 );
    for ( unsigned int i = 1; i < nbInPorts( ); i++ )
        expectInType( i, type );
}
```

The processData( ) method is funneling all input into the single output port. We have assured the type-compatibility of all input ports, so this does not violate the typing mechanism. Because the run-time system guarantees that each successive call will transfer data of the same or younger time, we adhere to the principle that any data stream must be ordered timewise.

```
void OrlaMerge::processData(
    const ObcTime& dataTime,
    const OdtHandleVector& dataVec
    )
{
    for(unsigned int i = 0; i < dataVec.entries( ); i++ )
        if( dataVec.at(i).isNil( ) == false ) send( dataVec.at( i ), 0 );
}
```

For safety reasons, sendo sets the pointer to zero to indicate that the datum ownership is relinquished and that it cannot be accessed anymore.

Block example: Class OrlaReadSQDADL In this example, we describe a producer-only block. The construction of a producer-only block follows a slightly different structure than that of a producer-consumer.

One difference in writing such a block is that the outputType( ) method must always be supplied. Remember, the default outputType( ) method would return the type of the corresponding input port.

Because no input ports exist, other means are used to activate the block so it can create and inject data into the network.

For this example, we consider the OrlaReadSQDADL library block. This block reads data from a provided stream (istream&) containing ASCII representations. First we present the class definition:

class OrlaReadSQDADL : public OrlaBlock
{
public:

OrlaReadSQDADL( istream& in );
virtual ˜OrlaReadSQDADL( );

protected:

virtual const OdtTypeInstance* outputType( unsigned int outPort );
virtual void configure( );
virtual void processTimer(const ObcTime&, OrlaTimer*);
istream* istr_;
ObcTime startTime_;
ObcTime endTime_;
OrlaTimer work_;
bool inRealTime_;
bool checkRealTime_;
OdtInstanceHandle d_;
OdtConcreteTypeInstance* outputType_;
bool startTimeOver_;

};

The OrlaReadSQDADL constructor takes as argument an istream& specifying from where the ASCII input data are to be read:

OrlaReadSQDADL::OrlaReadSQDADL(

ifstream ifstr)
: OrlaBlock( net, className ),
istr_( &istr; ),
nbLines_( 0 ),
work_( timerQueue( ) ),
inRealTime_( false ),
d_( 0 ),
output Type_( 0 ),
startTimeOver_( false )

{}

Because this is a producer-only block, configure( ) assures that no blocks are trying to feed data into it. It is calling its own outputType( ) method to initialize the output type.

void OrlaReadSQDADL::configure( )
{

expectInPortsEq( 0 );
expectOutPortsEq( 1 );
outputType(O);
if( !startTime_.isValid( ) ) startTime_ = startTime( );
if( !endTime_.isValid( ) ) endTime_ = endTime( );
checkRealTime_ = endTime_ > ObcTime::now( );
work_.set( start Time_ );

}

As noted above, the outputtype( ) method must be provided. It returns the type of data that we expect to read.

const OdtTypeInstance*
OrlaReadSQDADL::outputType( unsigned int outPort )
{

if( output Type_ == 0 ) {

// Read the data type from first line of file
RWCString sqdadl;
sqdadl. readLine( *istr_ );
nbLines_++;

OdtDatumParser parser;
outputType_ = parser.parseConcreteType(sqdadl);
}
return outputType_;

}

The processtimer( ) method does the main work for this producer block. It is initially called because the timer was set during the configuration phase. We will continue re-setting the timer as long as there's data available in the input file stream.

void
OrlaReadSQDADL::processTimer(const ObcTime& now,
OrlaTimer*)
{

if( d_ != 0 ) send( d_, 0 );
nbLines_++;
RWCString str;
str.readLine(*istr_);
// If empty line then issue end of data
if ( istr_->eof( ) ) {

sendEndOfData(O);
return;

}
try {

d_ = output Type_->createInstance( );
d_->populateFieldValues(str);

} catch( ObcException& e ) {

e.addLocation(“OrlaReadSQDADL::processTimer”);
throw e;

| } | |
|---|---|
| ObcTime tickTime = d_[“Timestamp”] | ( ).asTime( ); |

if( checkRealTime_ && !inRealTime_ && tickTime >
ObcTime::now ( ) ) {

| setProcessingMode(OrlaInputPort::realTime ); | |
|---|---|
| inRealTime_ = true; | |
| ObcLog::debug( className ) | << “Switching to r/t |

mode, line”
<< nbLines_ << ObcLog::
end( );

}
if ( ! startTimeOver_) {

if (startTime_ > tickTime ) {

discard(d_);
work_.set( startTime_ );
return;

} else {

startTimeOver_ = true;

}

if ( startTimeOver_ && endTime_ < tickTime ) {

discard(d_);
sendEndOfData(O);
return;

}
if ( ! inRealTime_) send( d_, 0 );
work_.set( tickTime );

}

Finally, when the block is destroyed, the destructor code needs to deallocate the dynamically allocated data:

OrlaReadSQDADL::˜OrlaReadSQDADL( )
{
}

More About the Run-Time System The ORLA run-time system was introduced earlier. The run-time system is that part of ORLA that manages what goes on internally. It is started when the network method runo is called for the respective object. It calls the blocks' respective processing methods, like configure( ) or processData( ).

Network Feedback Loops Generally block activation is managed transparently and hence is unimportant to the network developer. However, if a network contains a loop, the effects of flow-control can become significant. In particular, the network designer must be aware and avoid deadlock situations.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

A The SQDADL definition
# Master SQDADL BNF definition file
# $Id: //depot/main/local/config/SQDADL.bnf.txt#14 $
#
##############################################################################
### Most of the primitive field names are not used in more than one of the
### subsections below. In this case the field entry appears in that
### subsection. These fields are, however, so generic, that they are
### used almost everywhere, and I chose to put them here at the beginning
##############################################################################

| | |
|---|---|
| Name | = string:static |
| Period | = string:static ## For soft financial period units |
| Ccy | = string(3):static |
| Country | = string(3):static |
| Price | = float |
| Value | = float |
| DoubleValue | = double |

##############################################################################
### This is the top level structure for all ticks. Notice that this line
### has a format different than any other line in this file.
##############################################################################

| | |
|---|---|
| Tick | = ( Time, SeriesID, DataSpecies, Source, Validity ) |

########### Time ###########

| Time | = “Time” ( Timestamp, TimeMod ) |
|---|---|
| Timestamp | = time |
| TimeMod | = Regular \| Scaled \| RegularScaled \| empty |
| Regular | = “Regular” ( RegularTimelnterval ) |
| RegularTimeInterval | = timeInterval:static |
| Scaled | = “Scaled” ( TimeScale, ScaledTimeInterval ) |
| ScaledTimeInterval | = ScaledTimeInterval |
| RegularScaled | = “RegularScaled” ( TimeScale, RegularScaledTimeInterval) |
| RegularScaledTimeInterval | = ScaledTimeInterval:static |
| TimeScale | = enum( ‘physical’, ‘tick’, ‘market’, ‘intrinsic’, |
| | ‘theta’, ‘theta2stat’, ‘theta2dyn’ ) : static |

########### SeriesID ###########

| | |
|---|---|
| SeriesID | = Instrument \| Analytic |
| Instrument | = Contract \| Intangible |

########### CONTRACTS ###########

| | |
|---|---|
| Contract | = Asset \| Derivative |

########## ASSETS ##########

| | |
|---|---|
| Asset | = FX \| Commodity \| Equity \| Deposit \| Pfandbrief \| Bond \| BmkBond |
| FX | = “FX” ( Per, Expr ) |
| Per | = string(3):static |
| Expr | = string(3):static |
| Commodity | = “Commodity” ( Name, Ccy ) |
| Equity | = “Equity” ( Ticker, Ccy, Market ) |
| Ticker | = string:static |
| Deposit | = “Deposit” ( Ccy, Period ) |
| Pfandbrief | = “Pfandbrief” ( Issuer, CouponRate, Maturity, WKN ) |
| Issuer | = string:static |
| Maturity | = time |
| CouponRate | = float |
| WKN | = string:static # (WertpapierKennNummer) |
| Bond | = FixedBond \| ZeroBond \| FloatBond \| Brady |
| FixedBond | = “FixedBond” ( Ccy, Issuer, CouponRate, DayBasis, CouponFreq, Maturity ) |
| ZeroBond | = “ZeroBond” ( Ccy, Issuer, Maturity ) |
| FloatBond | = “FloatBond” ( Ccy, Issuer, InterestRate, CouponFreq, Maturity ) |
| CouponFreq | = string:static |
| ConvergFct | = float |
| Brady | = “Brady” ( Country, Ccy, BradyType, LiborSpread, Maturity ) |
| BradyType | = string : static |
| LiborSpread | = float |
| BmkBond | = “BmkBond” ( Ccy, Period, BmkType, Bond ) |
| BmkType | = enum( ‘Treasury’ ) : static |

########### DERIVATIVES ###########

| | |
|---|---|
| Derivative | = Future \| ROFuture I GenericFut \| Forward \| IRSwap \| VolDerivative |

# The derivatives with a price depending on the volatility
# Can be used to compute an implied volatility, as with ‘ImplVol’

| VolDerivative | = Option \| IRCap | |
|---|---|---|
| Future | = “Future” ( ExpYearMon, ExpiryDate, Exch, Ccy, Instrument ) | |
| ExpiryDate | = time | |
| ExpYearMon | = integer: static | # e.g. 199806 |
| Exch | = “Exch”( Name ) | |
| GenericFut | = “GenericFut” ( Exch ) | |
| ROFuture | = “ROFuture” ( ROInfo, Exch, Ccy, Instrument ) | |
| ROInfo | = “ROInfo”( Position, ROType, StartDate, RORange, ROValue, GlueFactor ) | |
| Position | = integer:static | |
| ROType | = string:static | # the rollover algorithm used |
| | # | |
| | # possible ROTypes: | |
| | # | |
| | # ConstMat: | convex combination with |
| | # | constant Maturity |
| | # [Vol]Add[NoGlue]: | additive mode |
| | # [Vol]Mult[NoGlue]: | multiplicative mode |
| | # Vol: | volume based rollover |
| | # NoGlue: | don't glue the series |
| RORange | = float:static | # EMA range for averaging |
| ROValue | = float | # Rolled-over price |
| GlueFactor | = float | # additive/multiplicative offset |
| | # | |
| | # the GlueFactor is defined by | |
| | # additive: | ROValue = Price - GlueFactor |
| | # multiplicative: | ROValue = Price * GlueFactor |

| Forward | = “Forward” ( Period, Instrument ) | |
|---|---|---|
| Option | = “Option” ( Strike, StrikeUnits, OptType, OptSide, Instrument, DerivSpec ) | |
| Strike | = float : static | |
| OptType | = enum( ‘American’, ‘European’, ‘NA’ ) : static | |
| OptSide | = enum( ‘call’, ‘put’, ‘straddle’, ‘NA’ ) : static | |
| DerivSpec | = ExchSpec \| OtcSpec | |
| ExchSpec | = “ExchSpec” ( ExpYearMon, ExpiryDate, Exch ) | |
| OtcSpec | = “OtcSpec” ( Period ) | |
| IRSwap | = “IRSwap” ( Ccy, IRBasis, Period, StartDate, Reset, DayBasis, InterestRate ) | |
| IRCap | = “IRCap” ( Ccy, Period, StartDate, Reset, DayBasis, InterestRate, CapType ) | |
| IRBasis | = emim( ‘B’, ‘M’, ‘NA’ ):static | # “B” = bond, “M” = money market |

| | | |
|---|---|---|
| StartDate | = time | # TODO: should this be a “date”:static |

| | | |
|---|---|---|
| Reset | = string: static | # It is a time period |

| | |
|---|---|
| DayBasis | = enum( ‘NA’, ‘ACT.360’, ‘ACT. 365’, ‘ACT.366’, |

‘30.360’, ‘30.365’, ‘30E.360’, ‘ACT.ACT’ ):static

| | |
|---|---|
| StrikeUnits | = enum( ‘REL’, ‘DIF’, ‘ABS’, ‘NA’ ):static |
| CapType | = enum( ‘cap’, ‘floor’ ):static |

########### INTANGIBLES ###########

| | |
|---|---|
| Intangible | = InterestRate \| Index \| TermIndex \| Deliverables \| ImplVol |
| InterestRate | = “InterestRate” ( Ccy, Period, IRReference ) |
| IRReference | = string : static |
| Index | = “Index” ( Name, Ccy ) |
| TermIndex | = “TermIndex” ( Name, Ccy, Period ) |
| Deliverables | = Notional \| Basket \| CtDNotional \| CtDBond |
| Notional | = “Notional” ( NotionalBond ) |
| NotionalBond | = “NotionalBond” ( Ccy, NominalMatur ity, Name ) |
| NominalMaturity | = timeInterval |
| Basket | = “Basket” ( Bond ) |
| CtDNotional | = “CtDNotional” ( Period ) |
| CtDBond | = “CtDBond” ( Name, Period, CouponRate, ConvergFct, ImpliedRepoRate, |

Maturity )

| | |
|---|---|
| ImpliedRepoRate | = float |
| ImplVol | = “ImplVol” ( VolDerivative ) |

########## ANALYTICS ##########

| | |
|---|---|
| Analytic | = HistVol \| Beta \| Corr \| IRCurve \| ImpliedIR \| Statistics \| OtmItem |
| HistVol | = “HistVol” ( TimeRange, TSModel, Instrument ) |
| TimeRange | = timeInterval:static |
| TSModel | = enum( ‘BIS’, ‘RiskMetrics’, ‘GARCH’, ‘OAUBF’, ‘OISIR’ ) : static |
| Beta | = “Beta” ( TimeRange, TSModel, MarketIndex, Equity ) |
| MarketIndex | = string:static |
| Corr | = “Corr” ( TimeRange, TSModel, Inst1, Inst2 ) |
| Inst1 | = “Inst1” ( Instrument ) |
| Inst2 | = “Inst2” ( Instrument ) |
| IRCurve | = “IRCurve” ( RiskMarket, Ccy, IRCurveType, YCModel, Compound, DayBasis, |

Period )

| | |
|---|---|
| RiskMarket | = enum( ‘interbank’, ‘treasury’, ‘pfandbrief’, ‘rex’, ‘pex’ ):static |
| IRCurveType | = enum (‘NA’, ‘Zero’, ‘Yield’, ‘Discount’, ‘ForwardRC’) : static |
| YCModel | = enum( ‘OA1’, ‘OA2’, ‘Algorithmics’, ‘Reuters’ ):static |
| Compound | = enum( ‘CC’, ‘daily’, ‘monthly’, ‘quarterly’, |

‘semiAnnual’, ‘annual’ ):static

| | |
|---|---|
| ImpliedIR | = “ImpliedIR” ( Ccy, Period, Instrument ) |
| Statistics | = “Statistics” ( Name, Instrument ) |
| Dtmltem | = “OtmItem” ( OtmModelID, Instrument ) |

########## DATASPECIES ##########

| | |
|---|---|
| DataSpecies | = MarketData \| LinearData \| ValueAddedData |

########## MARKET DATA ##########

| | |
|---|---|
| MarketData | = Quote \| Tx \| MktPrice \| MktVolume \| MktEvent \| |

BondPrice | Level | Summary | Curve | RefLevel

| | |
|---|---|
| Quote | = “Quote” ( Bid, Ask, Institution, DataMod ) |
| Bid | = float |
| Ask | = float |
| Institution | = string(4) |
| DataMod | = RefData \| QuoteSize \| empty |

### a basic quote does not contain anything else than bid/ask/institution

| | |
|---|---|
| RefData | = “RefData” ( RefTime, RefType, Market ) |
| RefTime | = time |
| RefType | = enum( ‘Fixing’, ‘Close’, ‘Settle’, ‘Interpolated’, |

‘Yield’, ‘Discount’ ) : static

| Market | = Exch \| Location \| empty | |
|---|---|---|
| Location | = “Location” ( Name ) | |
| QuoteSize | = “QuoteSize” ( BidSize, AskSize ) | |
| BidSize | = float | |
| AskSize | = float | |
| Tx | = “Tx” ( Price, Txlnfo ) | |
| TxInfo | = Vol \| Info \| empty | |
| Info | = “Info” ( Volume, Seller, Buyer ) | |
| Vol | = “Vol” ( Volume ) | |
| Volume | = integer | |
| Seller | = string (4) | |
| Buyer | = string (4) | |
| MktPrice | = “MktPrice” ( Price, Side ) | |
| Side | = enum(‘Bid’, ‘Ask’, ‘Mid’) : static | |
| MktVolume | = “MktVolume” ( Value, Side, VolType ) | |
| VolType | = enum(‘Cumulated’, ‘Generic’, ‘QSize’, ‘TxSize’, ‘Openlnt’ ) : static | |
| MktEvent | = “MktEvent” ( EventType, EffTime, Value) | |
| EventType | = enum (‘Dividend’, ‘Split’ ) : static | |
| EffTime | = time | |
| BondPrice | = “BondPrice” ( Bid, Ask, Tx, YieldBid, YieldAsk, Institution ) | |
| YieldBid | = float | |
| YieldAsk | = float | |
| Level | = “Level” ( Value, DataMod ) | |
| Summary | = “Summary” ( Market, Open, Close, High, Low ) | |
| Open | = float | |
| Close | = float | |
| High | = float | |
| Low | = float | |
| Curve | = SampledCurve \| ModeledCurve | |
| SampledCurve | = “SampledCurve” (Intercept, ValueVec) | |
| Intercept | = stringVec:static # array of periods | |
| ModeledCurve | = “ModeledCurve” ( CurveModel, Segments, Parameters ) | |
| CurveModel | = enum( ‘Algorithmics’, ‘OALinear’, ‘OAPolynom’ ) : static | |
| Segments | = timeIntervalVec | # TODO: static? |

| | | |
|---|---|---|
| Parameters | = doubleVec | # static |

| | |
|---|---|
| RefLevel | = “RefLevel” ( Value, DataMod, Side ) |

########## LINEAR DATA ##########

| LinearData | = Double \| DoubleVec # \| DoubleMatrix | |
|---|---|---|
| Double | = “Double” ( DoubleValue ) | |
| DoubleVec | = “DoubleVec” ( ValueVec, NElements ) | |
| ValueVec | = doubleVec | # number of elements is NElements |
| NElements | = integer:static | |

| | |
|---|---|
| # DoubleMatrix | = “DoubleMatrix” ( ValueMatrix, NRows, NCols ) |
| # ValueMatrix | = doubleMatrix |
| # NRows | = integer:static |
| # NCols | = integer:static |

########## VALUE ADDED DATA ##########

| ValueAddedData | = PointFcst \| CurveFcst \| VolCurve \| VolCurveFcst \| ScalarIndicator \| | |
|---|---|---|
| | ThresholdEvent \| OtmSpecies \| IRCorr \| ActivityHistogram \| Rate | |
| PointFcst | = “PointFcst” ( Value, TimeHorizon ) | |
| TimeHorizon | = timeInterval:static | |
| CurveFcst | = “CurveFcst” ( ValueVec, ConfIntervalVec, TimeHorizonVec ) | |
| ConfIntervalVec | = “ConfIntervalVec” ( HighVec, LowVec ) | |
| HighVec | = doubleVec | |
| LowVec | = doubleVec | |
| TimeHorizonVec | = timeIntervalVec | # TODO: static? |

| | |
|---|---|
| VolCurve | = “VolCurve” ( ValueVec, TimeHorizonVec ) |
| VolCurveFcst | = “VolCurveFcst” ( ValueVec, TimeHorizonVec ) |
| ScalarIndicator | = “ScalarIndicator”( Name, TimeHorizon, Value ) |
| ThresholdEvent | = “ThresholdEvent” ( ScalarIndicator, CrossingPrice, CrossingType ) |
| CrossingPrice | = float |
| CrossingType | = enum ( ‘OsUp’, ‘ObDown’, ‘ObUp’, ‘OsDown’ ) |
| IRCorr | = “IRCorr” ( CorrelationLevel, YieldCorr ) |
| CorrelationLevel | = float |
| YieldCorr | = float |
| ActivityHistogram | = SeasonalVolatility \| SeasonalTickFreq |
| SeasonalVolatility | = “SeasonalVolatility” ( DSTPeriod, Norm, Dt, DoubleVec ) |
| Norm | = integer:static |
| DSTPeriod | = integer:static ### Different daylight saving periods |
| Dt | = timeInterval |
| SeasonalTickFreq | = “SeasonalTickFreq” ( DSTPeriod, Dt, DoubleVec ) |
| Rate | = “Rate” ( RateValue ) |
| Rate Value | = float |

########## TRADING MODEL DATA ##########

| | |
|---|---|
| OtmModelID | = “OtmModelID” ( TMName, Customer, Market ) |
| TMName | = string:static |
| Customer | = string:static |
| OtmSpecies | = OtmDeal \| OtmStatus \| OtmRec \| OtmWrapper |
| OtmDeal | = “OtmDeal” ( PrevGearing, NewGearing, |

DealPrice, DealPriceTime, DealPriceSource,
DealReason, WasStopLossDeal,
MeanPrice, DealNumber,
TotalReturn, CumulatedReturn,
MinRetWhenOpen, MaxRetWhenOpen )

| | |
|---|---|
| OtmRec | = “OtmRec” ( Price, Reason, WasStopLossDeal, |

PrevGearing, NewGearing )

| | |
|---|---|
| Reason | = string |
| PrevGearing | = float |
| NewGearing | = float |
| DealPrice | = float |
| DealPriceTime | = time |
| DealPriceSource | = string |
| DealReason | = string |
| WasStopLossDeal | = bool |
| MeanPrice | = float |
| DealNumber | = integer |
| TotalReturn | = float |
| CumulatedReturn | = float |
| MinRetWhenOpen | = float |
| MaxRetWhenOpen | = float |
| OtmStatus | = “OtmStatus” ( Type, Message, Param ) |
| Message | = string |
| Param | = string |
| Type | = enum( ‘undefinedStatusType’, |

‘start Trading’, ‘endTrading’,
‘market Open’, ‘market OpenWarning’,
‘marketCloseWarning’, ‘marketLastChance’,
‘marketClose’, ‘otherMarketEvent’,
‘anticipateDeal’, ‘deal’,
‘noPriceData’, ‘priceDataOk’,
‘stopLossChange’, ‘numberOfStatusTypes’ ) : static

| | |
|---|---|
| OtmWrapper | = “OtmWrapper” ( DataType, DataNr, Data ) |
| DataType | = string |
| DataNr | = integer |
| Data | = integer |

########## SOURCE ##########

| | |
|---|---|
| Source | = “Source” ( Origin, Identifier, Version ) |
| Origin | = string:static |
| Identifier | = string:static |
| Version | = integer:static |

########## FILTER ##########

| | |
|---|---|
| Validity | = Filter \| empty |
| Filter | = “Filter” ( Confidence, Reasons, ScaleFactor ) |
| Confidence | = float |
| Reasons | = integer # Each bit of the integer corresponds to a reason |
| ScaleFactor | = float |

What is claimed in the present invention is

1. A system for storing one or more time series comprising:
(a) a language for describing the storing of the one or more time series; and
(b) a subsystem storing the one or more time series in accordance with said language.

2. A system for storing one or more time series as in claim 1 wherein said language comprises one or more attributes for representing one or more fields of the time series.

3. A system for storing one or more time series as in claim 2 wherein said subsystem comprises one or more rules for describing the storing of said one or more fields in accordance with said one or more attributes.

4. A system for storing one or more time series as in claim 3 wherein said subsystem further comprises:
(a) at least one file name; and
(b) at least one data file.

5. A system for storing one or more time series as in claim 4 wherein said one or more rules determine whether the fields are stored in said at least one file name or said at least one data file depending on values of said one or more attributes.

6. A system for storing one or more time series as in claim 1 wherein said language comprises one or more members of the set consisting of a leaf node, a non-leaf node, a type and a hint for describing one or more fields from the time series.

7. A system for storing one or more time series as in claim 6 wherein said subsystem comprises:
(a) at least one file name; and
(b) at least one data file.

8. A system for storing one or more time series as in claim 7 wherein said subsystem further comprises one or more rules for determining how to store at least one of the fields from the time series.

9. A system for storing one or more time series as in claim 8 wherein said rules comprise:
(a) storing the at least one field in said file name if the field is said non-leaf node.

10. A system for storing one or more time series as in claim 8 wherein said rules comprise: storing the at least one field in said filename if:
(a) the field is said leaf node; and
(b) the field has a fixed value for said hint.

11. A system for storing one or more time series as in claim 8 wherein said rules comprise: storing the at least one field in said data file if:
(a) the field is said leaf node;
(b) the field has a variable value for said hint; and
(c) the field has a constant size.

12. A system for storing one or more time series as in claim 8 wherein said rule comprise: storing a universal matching symbol in the filename if:
(a) the at least one field is said leaf node;
(b) the field has a variable value for said hint; and
(c) the field has a constant size.

13. A system for storing one or more time series as in claim 8 wherein said subsystem further comprises at least one secondary storage.

14. A system for storing one or more time series as in claim 13 wherein said rules comprise: store the at least one field in the secondary storage if:
(a) the field is said leaf node;
(b) the field has a variable value for said hint; and
(c) the field has a constant size.

15. A system for storing one or more time series as in claim 13 wherein said rules comprise: store a universal matching symbol in the filename if:
(a) the field is said leaf node;
(b) the field has a variable value for said hint; and
(c) the field has a constant size.

16. A system for storing one or more time series as in claim 13 wherein said rule comprises: copy an offset of the secondary storage into said data file if:
(a) the field is said leaf node;
(b) the field has a variable value for said hint; and
(c) the field has a constant size.

17. A system for storing one or more time series as in claim 1 wherein said language defines an exchange rate of one or more currencies.

18. A system for storing one or more time series as in claim 1 wherein said language defines a deposit of a currency for a period.

19. A system for storing one or more time series as in claim 1 wherein said language defines a quote.

20. A system for storing one or more time series as in claim 19 wherein said quote comprises one or more number of the set consisting of a bid, an ask, a bank and a source.

21. A system for storing one or more time series as in claim 1 wherein said language comprises a transaction.

22. A system for storing one or more time series as in claim 21 wherein said transaction comprises an exchange of a currency from a seller to a buyer.

23. A system for storing one or more time series as in claim 22 wherein said transaction further comprises one or more members of the set consisting of a price, a volume and a source.

24. A system for storing one or more time series as in claim 1 wherein said language comprises one or more regular expressions.

25. A system for storing one or more time series as in claim 1 wherein said language comprises one or more statements for defining one or more ticks in the time series.

26. A system for storing one or more time series as in claim 1 wherein said language is recursive.

27. A system for managing one or more time series comprising:
(a) a language defining a first one of the time series as a subset of a second one of the time series.

28. A system for managing one or more time series as in claim 27 wherein said second time series is a universal time series representing all recordable events.

29. A system for retrieving desired data from one or more time series comprising:
(a) at least one request comprising one or more restrictions for defining the desired data; and
(b) at least one utility retrieving data from the one or more time series that satisfies said one or more restrictions.

30. A system for retrieving desired data from one or more time series as in claim 29 further comprising:
(a) one or more rules for selecting one or more files comprising the one or more time series that satisfy said one or more restrictions.

31. A system for retrieving desired data from one or more time series as in claim 30 further comprising a language, said language defining one or more attributes for said one or more restrictions.

32. A system for retrieving desired data from one or more time series as in claim 31 wherein said one or more attributes comprise one or more members of the set consisting of a node type, a data type and a hint.

33. A system for retrieving desired data from one or more time series as in claim 32 wherein said one or more rules comprise: for at least one of said restrictions,
(a) select said one or more filename that match said at least one restriction if said node type of said at least one restriction is a non-leaf.

34. A system for retrieving desired data from one or more time series as in claim 32 wherein said one or more rules comprise: for at least one of said restrictions,
(a) select said one or more filenames having a universal matching symbol corresponding to said at least one restriction if:
(b) said node type of said at least one restriction is a leaf; and
(c) said hint of said restriction is a variable.

35. A system for retrieving desired data from one or more time series as in claim 33 wherein said one or more rules comprise: for at least one of said restrictions,
(a) select said one or more filenames that match said at least one restriction if:
(b) said node type of said at least one restriction is a leaf; and
(c) said hint of said at least one restriction is fixed.

36. A system for retrieving desired data from one or more time series as in claim 29 further comprising:
(a) at least one cursor for selecting data in the one or more time series that satisfies said one or more restrictions.

37. A system for retrieving desired data from one or more time series as in claim 36 wherein said one or more restrictions comprise one or more members of the set consisting of a base time and a time range.

38. A system for retrieving desired data from one or more time series as in claim 37 wherein said time range specifies the number of data items before said base time.

39. A system for retrieving desired data from one or more time series as in claim 37 wherein said time range specifies the number of data item after said base time.

40. A system for retrieving desired data from one or more time series as in claim 36 wherein said cursor comprises a first method for retriving the data item after a current time in the one or more time series that satisfies said one or more restrictions.

41. A system for retrieving desired data from one or more time series as in claim 36 wherein said cursor comprises:
(a) a second method for retrieving the data item before a current time in the one or more time series that satisfies said one or more restriction.

42. A system for retrieving desired data from one or more time series as in claim 29 further comprising:
(a) a parser for determining said one or more restrictions from said at least one request.

43. A system for retrieving desired data from one or more time series as in claim 29 wherein said one or more restrictions comprise an expression.

44. A system for processing data from one or more time series comprising:
(a) one or more processing modules for processing the data;
(b) one or more connections for linking said modules in a network; and
(c) a first subsystem for activating said one or more processing modules and for moving the data through the network.

45. A system for processing data from one or more time series as in claim 44 further comprising a type system comprising:
(a) one or more types; and
(b) a relation among said one or more types.

46. A system for processing data from one or more time series as in claim 45 further comprising a grammar to describe said types in said type system.

47. A system for processing data from one or more time series as in claim 45 wherein said one or more processing modules comprise one or more ports.

48. A system for processing data from one or more time series as in claim 47 further comprising one or more binding operators for creating said one or more connections to link two or more of said ports.

49. A system for processing data from one or more time series as in claim 48 wherein at least one of said types are assigned to at least one of said ports.

50. A system for processing data from one or more time series as in claim 49 wherein said one or more processing modules comprise:
(a) a configure method for checking that said types on said ports that are linked by one of said connections are consistent.

51. A system for processing data from one or more time series as in claim 44 wherein said processing modules comprise:
(a) a process data method to process the data.

52. A system for processing data from one or more time series as in claim 51 wherein said subsystem executes said process data method.

53. A system for processing data from one or more time series as in claim 44 wherein at least one datum of the data in the time series has at least one time stamp.

54. A system for processing data from one or more time series as in claim 53 wherein said subsystem:
(a) orders said at least one datum of the data according to said time stamp; and
(b) provides said ordered at least one datum to said processing modules.

55. A system for processing data from one or more time series as in claim 44 wherein said processing modules comprise one or more ports.

56. A system for processing data from one or more time series as in claim 55 wherein said ports comprise one or more input ports and one or more output ports.

57. A system for processing data from one or more time series as in claim 56 wherein said processing modules further comprise:
(a) at least one end of data method to indicate that no more data will be provided to said one or more input ports of said processing modules.

58. A system for processing data from one or more time series as in claim 57 wherein said first subsystem executes said end of data method when said subsystem has no more of the data to provide to said processing module.

59. A system for processing data from one or more time series as in claim 56 wherein said processing modules input at least one input datum of the data on said input ports, process said at least one input datum to produce at least one output datum, and output said at least one output datum on said output ports.

60. A system for processing data from one or more time series as in claim 59 wherein said processing module further comprises a build-up delay method that computes how much time said processing module needs before said processing module can output said at least one output datum that is meaningful.

61. A system for processing data from one or more time series as in claim 59 wherein said processing modules further comprise one or more timer methods to process one or more timers.

62. A system for processing data from one or more time series as in claim 61 wherein said one or more timers indicate when said processing modules should output said at least one output datum on said output ports.

63. A system for processing data from one or more time series as in claim 62 wherein said processing modules compute an average of input data and output said average at its said outputs at time intervals.

64. A system for processing data from one or more time series as in claim 63 wherein said time intervals are hourly.

65. A system for processing data from one or more time series as in claim 59 wherein said processing module comprise:
(a) at least one end of run method to indicate that said processing module should output any remaining said at least one output datum.

66. A system for processing data as in claim 65 wherein said first subsystem executes said end of run method.

67. A system for processing data from one or more time series as in claim 44 wherein said processing modules comprise one or more variables defining a state of said processing modules.

68. A system for processing data from one or more time series as in claim 44 wherein each of said processing modules execute independently of others of said processing modules.

69. A system for processing data from one or more time series as in claim 44 wherein said processing module further comprise:
(a) one or more timer methods to process one or more timers.

70. A system for processing data from one or more time series as in claim 69 wherein said first subsystem executes said timer methods.

71. A system for processing data from one or more time series as in claim 44 wherein the network is directed acyclic graph.

72. A system for processing data from one or more time series as in claim 44 wherein said processing modules comprise one or more members of the set consisting of producer-only modules that output data but do not input data, producer-consumer modules that input data and output data; and consumer-only modules that input data but do not output data.

73. A system for processing data from one or more time series as in claim 44 wherein said processing modules comprise one or more members of the set consisting of modules that read data from a repository, modules that perform financial calculations, modules that perform computations, modules that perform statistical analysis, modules that compute histograms, and modules that write data to the repository.

74. A system for processing data from one or more time series as in claim 73 wherein the computations comprise one or more members from the set consisting of:
(a) derivatives, volatility, generation of regular time series.

75. A system for processing data from one or more time series as in claim 73 wherein the financial calculation comprise a cross-rate with foreign exchange data.

76. A system for processing data from one or more time series as in claim 73 wherein the statistical analysis comprise one or more members of the set consisting of correlation, moving correlation and least square fit.

77. A system for processing data from one or more time series as in claim 73 wherein the histogram comprise one or more members of the set consisting of probability distribution, and conditional average and intra-week average.

78. A system for processing data from one or more time series as in claim 44 wherein said processing module process data from one or more time intervals.

79. A system for processing data from one or more time series as in claim 44 further comprising at least one start time and at least one end time.

80. A system for processing data from one or more time series as in claim 79 wherein said processing modules begin the processing of the data at said start time and continue processing the data until said end time.

81. A system for processing data from one or more time series as in claim 79 wherein said subsystem passes said start time and said end time to said processing modules.

82. A system for processing data from one or more time series as in claim 44 wherein at least one of said processing modules computes and produces a running average of at least one datum from the data that said processing modules receive.

83. A system for processing data from one or more time series as in claim 44 wherein at least one of said processing modules outputs an average of its said at least one received datum at every nth one of its said at least one received datum.
